(19) United States
(12) Patent Application Publication
(10) Pub. No.: US 2023/0078835 A1
(43) Pub. Date: Mar. 16, 2023

(54) SCHEDULING METHOD FOR UNRELATED PARALLEL MACHINE AND RELATED DEVICE THEREFOR

(71) Applicant: National University of Defense Technology, Changsha (CN)

(72) Inventors: Jianjiang WANG, Changsha (CN); Jin LIU, Changsha (CN); Guanfei YU, Changsha (CN); Manhao MA, Changsha (CN); Jianghan ZHU, Changsha (CN); Jing YU, Changsha (CN)

(21) Appl. No.: 17/693,042

(22) Filed: Mar. 11, 2022

(30) Foreign Application Priority Data
Aug. 26, 2021 (CN) 202110991175.3

(51) Int. Cl. G06F 17/12

(52) U.S. Cl. CPC G06F 17/12

(57) ABSTRACT

A scheduling scheme for an uncorrelated parallel machine is provided in this disclosure, in which a complex overlapping relationship between time windows are analyzed deeply and the upper bound for the linear relaxation of the model is improved. A new preprocessing algorithm is designed, which can successfully schedule more objects to be processed. Specifically, firstly, the first variable indicating whether the object to be processed is scheduled to the time window corresponding to the implementer and the second variable indicating the start time when the object to be processed is allocated to the time window are introduced into the model, and then conflicts or relationships between the time windows are analyzed, the corresponding scheduling scheme can be obtained according to different situations and the scheduling can be performed according to the scheduling scheme. A new improved mixed integer linear programming model (MILP) is obtained.

### CROSS REFERENCE TO RELATED APPLICATIONS

This application claims priority to Chinese patent application 202110991175.3 filed Aug. 26, 2021, the content of which are incorporated herein in the entirety by reference.

### TECHNICAL FIELD

The disclosure relates to a technical field of mixed integer linear programming, in particular to a scheduling method for an unrelated parallel machine and a related device therefor.

### BACKGROUND

An earth observation satellite is a satellite platform that images the earth's surface by a remote sensor (payload) on board in response to user demand. With an explosive growth of observation demand and limited resources, scheduling is very important to improve observation efficiency. Generally, the Earth observation satellite operates in a low orbit, and it can orbit the Earth ten to dozens of times a day. Obviously, the satellite can only observe a target successfully when flying over it, that is, the target must be within a visible range of the satellite. Therefore, a target observation is restricted in a time window. Because of operation in several orbits around the earth every day, as well as flexible maneuverability and field of view of the sensor, the satellite can observe the same target from several adjacent orbits. Therefore, there may be multiple time windows for a single satellite to observe a single target. With different orbits, there may be different time windows for different satellites to observe the same target. Further, it is required for the satellite to perform certain switching operations between continuously observing two targets, including sensor shutdown, yawing, attitude stabilization and restarting. Therefore, if each satellite is regarded as an implementer and each target is regarded as an object to be processed, a scheduling problem for the earth observation satellite can be described as a scheduling problem of an unrelated parallel machine with multiple time windows and switching time.

Similar problems also exist in scheduling by implementers in a production workshop and crew scheduling in enterprises, in which workpieces or tasks can only be allocated within the working time windows of implementers or employees. In addition, in most cases, the implementers or employees only work in daylight. Another typical application is a team orienteering problem with multiple time windows, in which customers cannot be visited during sleep time and working time. The difference is that the time windows in the above problems only depend on one of the implementer or the object to be processed, however the visibility is determined by the orbit of the satellite and a target position, and thus the time windows depend on both the object to be processed and the implementer.

### SUMMARY

In view of this, an object of this disclosure is to propose a scheduling method for an unrelated parallel machine and a related device therefor.

On a basis of the above object, the present disclosure provides a scheduling method for an unrelated parallel machine, which includes:

processing an object to be processed within a corresponding time window in response to determining that a first variable is 1, and taking a second variable to be 0 in response to determining that the first variable is 0; and scheduling the object to be processed according to the first variable and the second variable, wherein the first variable indicates whether the object to be processed is scheduled to a time window corresponding to an implementer, if the object to be processed is scheduled to the time window corresponding to the implementer, the first variable is 1, otherwise, the first variable is 0; and the second variable indicates a start time when the object to be processed are allocated to the time window, and each object to be processed is processed at most once;

processing the second object to be processed before the first object to be processed in response to determining that a latest end time of the first object to be processed is less than a sum of an earliest start time of the second object to be processed and switching time of the implementer; and processing the second object to be processed after the first object to be processed in response to determining that the latest end time of the first object to be processed is greater than the sum of the earliest start time of the second object to be processed and the switching time of the implementer;

processing the first object to be processed before the second object to be processed in response to determining that the third variable is 1; and processing the first object to be processed after the second object to be processed in response to determining that the fourth variable is 1; wherein the third variable and the fourth variable respectively indicate scheduling orders of the first object to be processed and the second object to be processed, and the third variable and the fourth variable satisfy switching time constraint, consistency constraint and the domain constraint; and establishing a mixed integer linear programming model according to above conditions, solving it to obtain a scheduling scheme for scheduling the object to be processed with a maximum total revenue, and scheduling the object according to the scheduling scheme.

On a basis of the same concept, a scheduling device for an unrelated parallel machine is also provide in this disclosure, which includes:

a first processing module configured to process an object to be processed within a corresponding time window in response to determining that a first variable is 1, and take a second variable to be 0 in response to determining that the first variable is 0; and schedule the object to be processed according to the first variable and the second variable, wherein the first variable indicates whether the object to be processed is scheduled to a time window corresponding to an implementer, if the object to be processed is scheduled to the time window corresponding to the implementer, the first variable is 1, otherwise, the first variable is 0; and the second variable indicates a start time when the object to be processed are allocated to the time window, and each object to be processed is processed at most once;

a second processing module configured to process the second object to be processed before the first object to be processed in response to determining that a latest end time of the first object to be processed is less than a sum of an earliest start time of the second object to be processed and switching time of the implementer; and process the second object to be processed after the first object to be processed in response to determining that the latest end time of the first object to be processed is greater than the sum of the earliest start time of the second object to be processed and the switching time of the implementer;

a third processing module configured to process the first object to be processed before the second object to be processed in response to determining that the third variable is 1; and process the first object to be processed after the second object to be processed in response to determining that the fourth variable is 1; wherein the third variable and the fourth variable respectively indicate scheduling orders of the first object to be processed and the second object to be processed, and the third variable and the fourth variable satisfy switching time constraint, consistency constraint and the domain constraint; and

a scheduling module configured to establish a mixed integer linear programming model according to above conditions, solving it to obtain a scheduling scheme for scheduling the object to be processed with a maximum total revenue, and schedule the object according to the scheduling scheme.

On a basis of the same concept, an electronic device is also provided in one or more embodiments of this specification, which includes a memory, a processor and a computer program stored on the memory and operable on the processor, and the processor implements the method described in any one of the above when executing the program.

From the above, it can be seen that in the scheduling method for the unrelated parallel machine and the related device provided in the present disclosure, the first variable indicating whether the object to be processed is scheduled to the time window corresponding to the implementer and the second variable indicating the start time when the object to be processed is allocated to the time window are introduced into the model, and then conflicts or relationships between the time windows are analyzed, the corresponding scheduling scheme can be obtained according to different situations and the scheduling can be performed according to the scheduling scheme. A new improved mixed integer linear programming model (MILP) is obtained, which avoids introduction of a “big M” variable and has a tighter upper bound for linear relaxation. The introduction of 0-1 variables among all objects to be processed is avoided, and solving efficiency of the scheduling scheme can be improved.

### BRIEF DESCRIPTION OF THE DRAWINGS

In order to explain technical schemes in this disclosure or related technologies more clearly, the drawings required in the description of the embodiments or the related art will be briefly introduced below; obviously, the drawings in the following description are only embodiments of the present disclosure, and other drawings can be obtained according to these drawings by those of ordinary skill in the art without paying creative labor.

FIG. 1 is a flow chart of a scheduling method for an unrelated parallel machine according to an embodiment of the present disclosure;

FIG. 2 is a preprocessing flow chart of a scheduling method for an unrelated parallel machine according to an embodiment of the present disclosure;

FIG. 3(a) and FIG. 3(b) are schematic diagrams of different situations for two time windows according to an embodiment of the present disclosure;

FIGS. 4(a)-(j) are schematic diagrams of different situations for three time windows according to the embodiment of the present disclosure;

FIG. 5 is a flow chart of finding a non-dominant inequality according to an embodiment of the present disclosure;

FIG. 6 is a schematic diagram of an example recognition and addition of an inequality according to an embodiment of the present disclosure;

FIG. 7 is a structural schematic diagram of a scheduling device for an unrelated parallel machine according to an embodiment of the present disclosure;

FIG. 8 is a schematic structural diagram of an electronic device according to an embodiment of the present disclosure;

FIG. 9 is a block diagram illustrating an exemplary computing system in which the present system and method can operate according to an embodiment of the present disclosure;

FIG. 10 is a conceptual data flow diagram illustrating the data flow between different means/components in an exemplary apparatus according to an embodiment of the present disclosure; and

FIG. 11 is a diagram illustrating an example of a hardware implementation for an apparatus employing a processing system according to an embodiment of the present disclosure.

### DETAILED DESCRIPTION

In order to make the objects, technical schemes and advantages of the disclosure more clear, the disclosure will be further described in detail with reference to specific embodiments and drawings.

It should be noted that, unless otherwise defined, technical terms or scientific terms used in the embodiments of this disclosure shall have a general meaning understood by those with general skills in the field to which this disclosure pertains. Words “first”, “second” and the like used in the embodiments of this disclosure do not indicate any order, quantity or importance, but are only used to distinguish different components. Similar words such as “including” or“containing” mean that the elements or objects appearing before the words encompass listed elements or objects appearing after the word and their equivalents, with other elements or objects being not excluded. Similar words such as “connected to” or “connected with” are not limited to physical or mechanical connection, but can include electrical connection, direct or indirect. An expression such as “upper”, “lower”, “left” and “right” is only used to express a relative positional relationship. When an absolute position of a described object changes, the relative positional relationship may also change accordingly.

As mentioned in the background art, the scheduling problem of the unrelated parallel machine exists in all aspects of production and life. In realizing this disclosure, the applicant found that existing solutions to the scheduling problem of the unrelated parallel machine with multiple time windows are very limited. Many scholars have studied the scheduling problem of the unrelated parallel machine with the time windows, and extended their research work to a field of satellite scheduling. In order to improve antenna utilization of a Tracking and Data Relay Satellite System (TDRSS), Rojanasoonthon and Bard studied the scheduling problem of the uncorrelated parallel machines with the time windows. Firstly, a mixed integer linear programming model is established, but considering this complex model, it is difficult to solve large-scale problems in reality. They used two heuristic algorithms to solve the model, the first one is the Greedy Randomized Adaptive Search Algorithm (GRASP), which contains two stages. In a first stage, the object to be processed are sorted by a greedy function, and each object to be processed is scheduled one by one in order to generate an initial feasible solution. In a second stage, a local optimal solution is searched by inserting the object to be processed and swapping neighborhood. Then, a heuristic algorithm similar to dynamic programming is proposed, which is called R-B algorithm. A basic idea of the R-B heuristic algorithm is to construct a directed acyclic graph from priority relations among the objects to be processed, and then to search a longest path of the directed graph. An optimal solution usually cannot be obtained for meta-heuristic algorithms and optimality of the solution also cannot be guaranteed and evaluated, Rojanasoonthon and Bard thus further try to solve the optimal solution to this problem. Based on a special structure of the problem, the mixed integer linear programming model is reconstructed into independent subset major problems and multiple short-path pricing subproblems, and a branch and price algorithm is designed. More comprehensively, the above GRASP heuristic algorithm is used to solve a pricing subproblem. In their research, each object to be processed has multiple time windows, but each object to be processed has only one or two time windows at most on each implementer, and a situation with more time windows is not considered.

Chen studied a scheduling problem of Earth observation satellites, which is a variant of the scheduling problem of the uncorrelated parallel machines with the time windows. In the study, each object to be processed has multiple time windows on each implementer. By analyzing interdependence among feasible time windows, a new mixed integer linear programming model is designed, and linear relaxation of the model is tightened by improved constraints. Then, a preprocessing algorithm is proposed to reduce a problem size and facilitate solving the algorithm. However, in practical work, because of introduction of a “big M” parameter in the traditional model, it is difficult to obtain a tight upper bound for the linear relaxation of the model. In the traditional model, for any two objects to be processed and any implementer k, it is necessary to define a 0-1 variable yᵢⱼ^{k}, I, j∈J, k∈M, so the number of the variables yᵢⱼ^{k} is n²m. Therefore, a loose upper bound for the linear relaxation and a large number of 0-1 variables make the traditional model difficult to solve effectively.

In view of this, a scheduling scheme for an uncorrelated parallel machine is provided in one or more embodiments of this disclosure, in which a complex overlapping relationship between time windows are further analyzed deeply and the upper bound for the linear relaxation of the model is improved. A new preprocessing algorithm is designed, which can successfully schedule more objects to be processed. Specifically, firstly, the first variable indicating whether the object to be processed is scheduled to the time window corresponding to the implementer and the second variable indicating the start time when the object to be processed is allocated to the time window are introduced into the model, and then conflicts or relationships between the time windows are analyzed, the corresponding scheduling scheme can be obtained according to different situations and the scheduling can be performed according to the scheduling scheme. A new improved mixed integer linear programming model (MILP) is obtained, which avoids introduction of a “big M” variable and has a tighter upper bound for linear relaxation. The introduction of 0-1 variables among all objects to be processed is avoided, and solving efficiency of the scheduling scheme can be improved.

Hereinafter, technical schemes on one or more embodiments of the present disclosure will be explained in detail through specific embodiments.

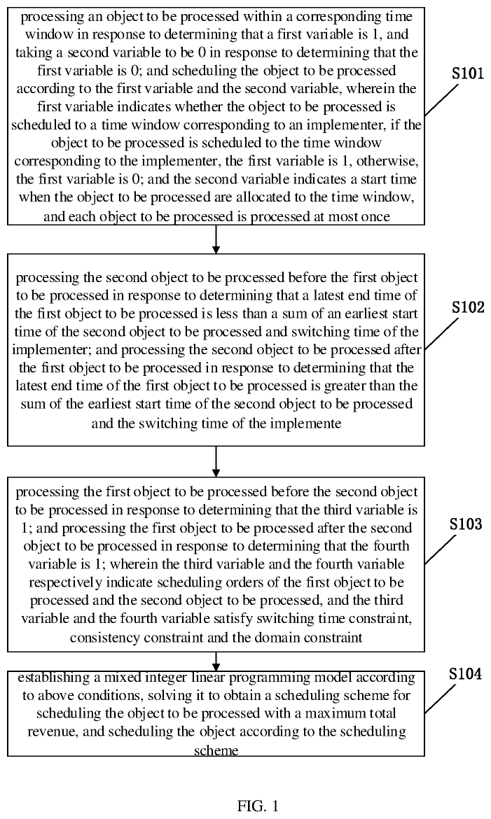

Referring to FIG. 1, a scheduling method for an unrelated parallel machines according to an embodiment of this disclosure includes following steps S101 to S104:

In S101, an object to be processed within a corresponding time window is processed in response to determining that a first variable is 1, and a second variable is taken to be 0 in response to determining that the first variable is 0; and the object to be processed is scheduled according to the first variable and the second variable. The first variable indicates whether the object to be processed is scheduled to a time window corresponding to an implementer, if the object to be processed is scheduled to the time window corresponding to the implementer, the first variable is 1, otherwise, the first variable is 0; and the second variable indicates a start time when the object to be processed are allocated to the time window, and each object to be processed is processed at most once.

In this embodiment, the object to be processed and the implementer may be different in different implementation scenarios. In a scenario of machining mechanical parts, the object to be processed may be a part to be machined, and the implementer may be a lathe. In a vehicle routing problem, the object to be processed can be a path of the vehicle, and the implementer can be the vehicle itself; and in a scenario of satellite scheduling, the object to be processed can be a task of the satellite, and the implementer can be the satellite itself.

In S102, the second object to be processed is processed before the first object to be processed in response to determining that a latest end time of the first object to be processed is less than a sum of an earliest start time of the second object to be processed and switching time of the implementer; and the second object to be processed is processed after the first object to be processed in response to determining that the latest end time of the first object to be processed is greater than the sum of the earliest start time of the second object to be processed and the switching time of the implementer.

In S103, the first object to be processed is processed before the second object to be processed in response to determining that the third variable is 1; and the first object to be processed is processed after the second object to be processed in response to determining that the fourth variable is 1. The third variable and the fourth variable respectively indicates scheduling orders of the first object to be processed and the second object to be processed, and the third variable and the fourth variable satisfy switching time constraint, consistency constraint and the domain constraint.

In S104, a mixed integer linear programming model is established according to above conditions, and solved to obtain a scheduling scheme for scheduling the object to be processed with a maximum total revenue, and the object is scheduled according to the scheduling scheme.

In this step, the mixed integer linear programming model can be expressed as:

$$max {\sum }_{j ∈ J} {\sum }_{k ∈ M} {\sum }_{l ∈ {TW}_{ik}} {w}_{i} \cdot {x}_{ik}^{l}$$

Here, the model represents a maximum total profit of scheduling the object to be processed, which includes two virtual object to be processed, namely {0, n+1}, which correspond to a starting and ending objects to be processed, J represents a set of the objects to be processed, M represents a set of the implementers, I, j∈J∪{0, n+1}, k∈M, l∈TWⱼₖ and for each object j to be processed, j∈J, the profit is wⱼ, xⱼₖ^{l} represents the first variable and is a binary variable. If the object j to be processed is scheduled to a 1-th time window on an implementer k, xⱼₖ^{l}=1, Otherwise, xⱼₖ^{l}=0; there are multiple time windows for each object to be processed j and each implementer k, which are defined as TWⱼₖ={twⱼₖ¹, twⱼₖ², . . . , twᵢₖ^{|TW}^{ⱼₖ}^{|}}, |TWⱼₖ| represents a number of time windows of the object to be processed j on the implementer k, twⱼₖ^{l}=[wsⱼₖ^{l}, weⱼₖ^{l}] represents the 1-th time window of the object to be processed j on the implementer k, and wsⱼₖ^{l}, weⱼₖ^{l} respectively represents an earliest start time and a latest end time of the object to be processed j on the implementer k, that is, time nodes at both ends of the l-th time window on the implementer k.

In this embodiment, each object to be processed should be scheduled within a certain time window. Otherwise, it cannot be scheduled. In addition, each object to be processed should be processed once without interruption, so this model focuses on non-preemptive scheduling, and a scheduling goal is to maximize the total profit of the object to be processed.

In this embodiment, the mixed integer linear programming model specifically includes:

$${\sum }_{k ∈ M} {\sum }_{l ∈ {TW}_{ik}} {x}_{ik}^{l} \leq 1 , j ∈ J$$

This constraint ensures that each object to be processed is scheduled at most once.

xⱼₖ^{l}∈{0,1},i,j∈J,k∈M,l∈TWⱼₖ

This constraint is domain constraint of the first variable.

wsⱼₖ^{l}xⱼₖ^{l}≤tⱼₖ^{k},j∈J,k∈M,l∈TWⱼₖ

(weⱼₖ^{l}−pⱼ)·xⱼₖ^{l}≥tⱼₖ^{l},j∈J,k∈M,l∈TWⱼₖ

The above two constraints are time window constraints, which correspond to the following in step S101: the object to be processed within the corresponding time window is processed in response to determining that the first variable is 1, and the second variable is taken to be 0 in response to determining that the first variable is 0. In which, tⱼ, j∈J∪{0, n+1} is the second variable, which is a real variable, indicating the start time corresponding to the time window twⱼₖ^{l} to which a workpiece j is assigned, and pⱼ indicates processing time.

For two time windows twᵢₖ^{g} and twⱼₖ^{l} of two objects I, j to be processed (the first object to be processed and the second object to be processed) on the implementer k, if weⱼₖ^{l}-pⱼ-wsᵢₖ^{g}<Δₖ, which means that if both objects to be processed are scheduled to the implementer k, that is, xᵢₖ^{g}=1 and xⱼₖ^{l}=1, then the object to be processed j must be processed before the object to be processed I, thus it is obtained that:

tᵢₖ^{g}−tⱼₖ^{l}≥(pⱼ+Δₖ)·xⱼₖ^{l}−(weⱼₖ^{l}+Δₖ)·(1−xᵢₖ^{g})

This constraint is a switching time constraint, which corresponds to the following in step S102: the second object to be processed is processed before the first object to be processed in response to determining that a latest end time of the first object to be processed is less than a sum of an earliest start time of the second object to be processed and switching time of the implementer. Here, tⱼ, j∈J∪{0, n+1} represents the second variable, pⱼ represents the processing time, and Δₖ represents implementer switching time for each implementer k, k∈M.

For two time windows twᵢₖ^{g} and twⱼₖ^{l} of two objects I, j to be processed on the implementer k, if weᵢₖ^{g}−pᵢ−wsⱼₖ^{l}<Δₖ, which means that if both objects to be processed are scheduled to the implementer k, that is, xᵢₖ^{g}=1 and xⱼₖ^{l}=1, then the object to be processed j must be processed before the object to be processed I, thus it is obtained that:

tⱼₖ^{l}−tᵢₖ^{g}≥(pᵢ+Δₖ)·xᵢₖ^{g}−(weᵢₖ^{g}+Δₖ)·(1−xⱼₖ^{l})

This constraint is a switching time constraint, which corresponds to the following in step S102: the second object to be processed is processed after the first object to be processed in response to determining that the latest end time of the first object to be processed is greater than the sum of the earliest start time of the second object to be processed and switching time of the implementer.

If both objects to be processed I, j are scheduled to the implementer k, a processing order of the two objects to be processed cannot be confirmed. Therefore, it is necessary to introduce an auxiliary 0-1 variable: a third variable yᵢⱼₖ^{g}^{ₗ} and a fourth variable yⱼᵢₖ^{l}^{_{g}}, if the object I is processed before the object j, the third variable yᵢⱼₖ^{g}^{ₗ}=1; otherwise, if the object j is processed before the object I, the fourth variable yⱼᵢₖ^{l}^{_{g}}=1. On this basis, the switching time constraint can be defined by the third variable yᵢⱼₖ^{l}^{_{g}} and the fourth variable yⱼᵢₖ^{l}^{_{g}} as follows:

tⱼₖ^{l}−tᵢₖ^{g}≥(weᵢₖ^{g}+Δₖ)·yᵢⱼₖ^{g}^{ₗ}+weⱼₖ^{l}·yⱼᵢₖ^{l}^{_{g}}−(weᵢₖ^{g}−pᵢ)

tᵢₖ^{g}−tⱼₖ^{l}≥(weⱼₖ^{l}+Δₖ)·yⱼᵢₖ^{l}^{_{g}}+wsᵢₖ^{g}·yᵢⱼₖ^{g}^{ₗ}−(weⱼₖ^{l}−pⱼ)

In addition, the first variable xⱼₖ^{l} (0-1 variable), the third variable and the fourth variable yⱼᵢₖ^{l}^{_{g}} (the auxiliary 0-1 variable) must also satisfy consistency constraint:

$${y}_{ijk}^{gl} + {y}_{jik}^{lg} \leq {x}_{ik}^{g} , i , j ∈ J , k ∈ M , g ∈ {TW}_{ik} , l ∈ {TW}_{jk}$$

$${y}_{ijk}^{gl} + {y}_{jik}^{lg} \leq {x}_{jk}^{l} , i , j ∈ J , k ∈ M , g ∈ {TW}_{ik} , l ∈ {TW}_{jk}$$

$${y}_{ijk}^{gl} + {y}_{jik}^{lg} \geq {x}_{ik}^{g} + {x}_{jk}^{l} - 1 , i , j ∈ J , k ∈ M , g ∈ {TW}_{ik} , l ∈ {TW}_{jk}$$

$${\sum }_{k ∈ M} {\sum }_{g ∈ {TW}_{ik}} {\sum }_{l ∈ {TW}_{jk}} {y}_{ijk}^{gl} + {y}_{jik}^{lg} \leq 1 , i , j ∈ J$$

Meanwhile, the third variable yᵢⱼₖ^{g}^{ₗ} and the fourth variable yⱼᵢₖ^{l}^{_{g}} need to satisfy domain constraints:

yᵢⱼₖ^{g}^{ₗ}∈{0,1},i,j∈J∪{0,n+1},k∈M,g∈TWᵢₖ,l∈TWⱼₖ

tᵢⱼ^{k}∈R⁺,i,j∈J,k∈M.

It can be seen that in this embodiment, by introducing the second variable tⱼ, j∈J∪{0, n+1} and the auxiliary 0-1 variable yᵢⱼₖ^{g}^{ₗ}, yⱼᵢₖ^{l}^{_{g}} (the third variable and the fourth variable), a new improved MILP model is obtained: the new model avoids introducing the “big M” variable and has a tighter upper bound for linear relaxation. By analyzing conflicts and relationships among time windows, introduction of auxiliary 0-1 variables among all objects to be processed is avoided, but additional and more complex five-index 0-1 variables are introduced in this embodiment: the third variable and the fourth variable. However, this method is effective for improving solving efficiency because the variables are only introduced between part of the time windows.

A specific application scenario of the scheduling method for the unrelated parallel machine according to the present disclosure is given in the following. Algorithms are realized by calling CPLEX 12.8 API with C++. A compiler is Visual Studio 2017, running on Intel I core Ii7-5960x CPU @ 3.00 ghz (16 processors) computer, with 64 Gb memory and Windows 7 operating system.

In order to evaluate performance of the disclosed model and algorithms, a large number of problem instances are created through simulation. In this example, the object to be processed is the workpiece, and the implementor is a machine. Numbers of machines are 5, 10, 15 and 20 respectively. In addition, a number of time windows in each time interval is randomly generated in ranges of [5,10], [10,15], [15,20] and [20,25]. According to the number of the machines, a number of the workpieces is set from small to large. Therefore, a minimum number of the workpieces is 100 and the maximum number of the workpieces is 1200. The processing time of workpieces is uniformly distributed in a range of [240,360], and the switching time of each machine is uniformly distributed and randomly generated in a range of [180,300]. In addition, a scheduling period is set to be 24 hours. A length of the time window is generated in a interval [400,2000] in seconds. With combination of different numbers of machines and workpieces, a total of 47 problem instances were produced. Detailed parameters of all problem instances are given in Table 1.

TABLE 1
Test Instance.

| Instance | [M] | [I] | [J] | [EJ] | [TW] |
|---|---|---|---|---|---|
| 5-5-100 | [symbol] | [5, 10] | 100 | 98 | 430 |
| 5-5-200 | [symbol] | [5, 10] | 200 | 179 | 438 |
| 5-10-200 | 5 | [10, 15] | 200 | 193 | 741 |
| 5-10-100 | [symbol] | [10, 15] | 400 | 350 | 752 |
| 5-15-200 | 5 | [15, 20] | 200 | 200 | 1030 |
| 5-15-100 | [symbol] | [15, 20] | 400 | 379 | 1043 |
| 5-20-200 | 5 | [20, 25] | 200 | 200 | 1306 |
| 5-20-400 | 5 | [20, 25] | 400 | 385 | 1313 |
| 5-20-600 | [symbol] | [20, 25] | 600 | 573 | 13 [symbol] |
| 10-5-200 | 10 | [5, 10] | 200 | 196 | 898 |
| 10-5-400 | 10 | [5, 10] | 400 | 3 [symbol] 7 | 914 |
| 10-10-200 | 10 | [10, 15] | 200 | 200 | 1482 |
| 10-10-400 | 10 | [10, 15] | 400 | 307 | 1480 |
| 10-10-600 | 10 | [10, 15] | 600 | 556 | 1484 |
| 10-15-400 | 10 | [15, 20] | 400 | 398 | 2118 |
| 10-15-600 | 10 | [15, 20] | 600 | 584 | 2102 |
| 10-15-800 | 10 | [15, 20] | 800 | 755 | 2084 |
| 10-20-400 | 10 | [20, 25] | 400 | 399 | 2661 |
| 10-20-600 | 10 | [20, 25] | 600 | 594 | 2678 |
| 10-20-800 | 10 | [20, 25] | 800 | 793 | 2698 |
| 10-20-1000 | 10 | [20, 25] | 1000 | 961 | 2716 |
| 15-5-200 | 15 | [5, 10] | 200 | 200 | 1323 |
| 15-5-400 | 15 | [5, 10] | 400 | 391 | 1330 |
| 15-5-600 | 15 | [5, 10] | 600 | 548 | 1332 |
| 15-10-400 | 15 | [10, 15] | 400 | 3 [symbol] 9 | 2248 |
| 15-10-600 | 15 | [10, 15] | 600 | [symbol] | 2215 |
| 15-10-800 | 15 | [10, 15] | 800 | 766 | 2229 |
| 15-15-400 | 15 | [15, 20] | 400 | 400 | 3100 |
| 15-15-600 | 15 | [15, 20] | 600 | 599 | 3188 |
| 15-15-800 | 15 | [15, 20] | 800 | 793 | 3150 |
| 15-15-1000 | 15 | [15, 20] | 1000 | 979 | 3155 |
| 15-20-600 | 15 | [20, 25] | 600 | 599 | 4031 |
| 15-20-800 | 15 | [20, 25] | 800 | 797 | 4027 |
| 15-20-1000 | 15 | [20, 25] | 1000 | 99 [symbol] | 4040 |
| 20-5-400 | 20 | [5, 10] | 400 | 395 | 17 [symbol] 1 |
| 20-5-600 | 20 | [5, 10] | 600 | [symbol] 88 | 1780 |
| 20-5-800 | 20 | [5, 10] | 800 | 731 | 1846 |
| 20-10-400 | 20 | [10, 15] | 400 | 400 | 2981 |
| 20-10-600 | 20 | [10, 15] | 600 | 596 | 2970 |
| 20-10-800 | 20 | [10, 15] | 800 | 792 | 3018 |
| 20-10-1000 | 20 | [10, 15] | 1000 | 973 | 2990 |
| 20-15-600 | 20 | [15, 20] | 600 | 60 [symbol] | 4227 |
| 20-15-800 | 20 | [15, 20] | 800 | 797 | 4219 |
| 20-15-1000 | 20 | [15, 20] | 1000 | 991 | 4179 |
| 20-20-800 | 20 | [20, 25] | 800 | 800 | 5365 |
| 20-20-1000 | 20 | [20, 25] | 1000 | 998 | 5380 |
| 20-20-1200 | 20 | [20, 25] | 1200 | 1191 | 5425 |

[symbol]

indicates data missing or illegible when filed

In table 1, a column “Instance” represents an identifier of each instance. In addition, columns “|M|”, “|I|”, “|J|”, “|EJ|” and “|TW|” respectively represent a number of the machines, a number of the time windows in each interval, a number of the workpieces, a number of effective workpieces (with available time windows) and a total number of the time windows.

In order to test the performance of the model and algorithms in this embodiment, solution results are compared with those of Chen et al. Comparison results are shown in Table 2, where “Objective” represents an objective function value, that is, the total profit of the object to be processed. “Gap” represents a distance between a feasible solution and a upper bound of the optimal solution, which is calculated by (UB−Fea)/UB, where UB represents the upper bound of the optimal solution and Fea represents the objective function value of the feasible solution. Solution time is set to be 20 minutes. If the optimal solution is found within 20 minutes, the solution time is displayed in the column “Time(s)”.

As shown in Table 2, both the method of this embodiment and the method of Chen et al. can provide the a solution to most instances. Specifically, the number of instances for which the optimal solution is obtained by the method of this embodiment is larger than that by Chen et al. (39>34). In addition, for most (21) of instances (33) for which both of the methods can get the optimal solution, the solution time of the method in this embodiment is shorter than that of Chen et al. The main reasons are as follows: 1) The preprocessing algorithm in this embodiment makes more workpieces pre-scheduled, which reduces scale of problem solving; 2) with more effective inequalities are added, the upper bound of linear relaxation of the model in this embodiment is tighter, which facilitates problem solving.

TABLE 2
Performance evaluation of the model and solving algorithms in this embodiment.

| | Upper | Our model algorithms | | | Ch [symbol] et [symbol] model algorithms [7] | | |
|---|---|---|---|---|---|---|---|
| Instance | b [symbol] nd | Objective | Gap | Time(s) | Objective | Gap | Time(s) |
| 5-5-100 | [symbol] 76 | [symbol] 76 | 0 | 0.076 | 576 | 0 | 0.077 |
| 5-5-200 | 1012 | 1012 | 0 | 0.089 | 1012 | 0 | 0.144 |
| 5-10-200 | 1081 | 1081 | 0 | 0.171 | 1081 | 0 | 0.125 |
| 5-10- [symbol] 00 | 1 [symbol] | 1 [symbol] 8 | 0 | 15.303 | 1 [symbol] 68 | 0 | 63.733 |
| 5-15-200 | 1129 | 1129 | 0 | 16.458 | 1129 | 0 | 30. [symbol] 1 |
| 5-15- [symbol] 00 | 2110 | 2110 | 0 | 207.059 | 2110 | 0 | 259.941 |
| 5-20-200 | 1129 | 1129 | 0 | 40.981 | 1129 | 0 | 116.818 |
| 5-20- [symbol] 00 | 2163 | 2163 | 0 | 1050.110 | 2161 | 0.001 | — |
| 5-20-600 | 313 [symbol] | 1036 | 0. [symbol] 9 | — | 1029 | 0.672 | — |
| 10-5-200 | 1103 | 1103 | 0 | 0.078 | 1103 | 0 | 0.047 |
| 10-5-400 | 2041 | 2041 | 0 | 0.125 | 2041 | 0 | 0.125 |
| 10-10-200 | 1129 | 1129 | 0 | 0.1 [symbol] | 1129 | 0 | 0.078 |
| 10-10-400 | 2237 | 2237 | 0 | 0.265 | 2237 | 0 | 0.265 |
| 10-10-600 | 3045 | 3045 | 0 | 0.686 | 3045 | 0 | 60.139 |
| 10-15-400 | 2241 | 2241 | 0 | 86.769 | 2241 | 0 | 105.800 |
| 10-15-600 | 3205 | 3205 | 0 | 189.321 | 3205 | 0 | 318.077 |
| 10-15-800 | 4095 | 4095 | 0 | 740.211 | 4067 | 0.010 | — |
| 10-20-400 | 2173 | 2173 | 0 | 106.921 | 2173 | 0 | 219.001 |
| 10-20-600 | 3238 | 3238 | 0 | 509.098 | 3238 | 0 | 525.2 [symbol] 1 |
| 10-20-800 | 4320 | 2422 | 0.439 | — | 151 | 0. [symbol] 65 | — |
| 10-20-1000 | 5302 | 179 | 0.966 | — | 5028 | 0.052 | — |
| 15-5-200 | 1111 | 1111 | 0 | 0.078 | 1111 | 0 | 0.063 |
| 15-5-400 | 2172 | 2172 | 0 | 0.124 | 2172 | 0 | 0.109 |
| 15-5-600 | 3024 | 3024 | 0 | 0.234 | 3024 | 0 | 0.2 [symbol] |
| 15-10-400 | 2218 | 2218 | 0 | 0.296 | 2218 | 0 | 0.343 |
| 15-10-600 | 3290 | 3290 | 0 | 0.687 | 3290 | 0 | 0.639 |
| 15-10-800 | 4211 | 4211 | 0 | 1.312 | 4211 | 0 | 89.831 |
| 15-15-400 | 222 [symbol] | 2223 | 0 | 1.216 | 2223 | 0 | 49.230 |
| 15-15-600 | 3356 | 3356 | 0 | 223.717 | 3356 | 0 | 298.869 |
| 15-15-800 | 4328 | 4328 | 0 | 299.571 | 4303 | 0.006 | 955.558 |
| 15-15-1000 | 5361 | 531 [symbol] | 0.009 | — | 5325 | 0.007 | — |
| 15-20-600 | 3235 | 3235 | 0 | 330.303 | 3235 | 0 | 634.947 |
| 15-20-800 | 4338 | 4334 | 0.001 | 1027.100 | 4338 | 0 | 1142.160 |
| 15-20-1000 | 5431 | 239 | 0.956 | — | 208 | 0.962 | — |
| 20-5-400 | 2207 | 2207 | 0 | 0.141 | 2207 | 0 | 0.156 |
| 20-5-600 | 3149 | 3149 | 0 | 0.203 | 3149 | 0 | 0.203 |
| 20-5-800 | 3 [symbol] 51 | 3 [symbol] 51 | 0 | 0.358 | 3951 | 0 | 0.3 [symbol] 0 |
| 20-10-400 | 2208 | 2208 | 0 | 0.374 | 2208 | 0 | 0.29 [symbol] |
| 20-10-600 | 31 [symbol] 5 | 31 [symbol] 5 | 0 | 0.546 | 31 [symbol] 5 | 0 | 0.531 |
| 20-10-800 | 4815 | 4815 | 0 | 1.529 | 4810 | 0 | 62.082 |
| 20-10-1000 | 5303 | 5303 | 0 | 3.278 | 52 [symbol] 6 | 0.001 | 14 [symbol] . [symbol] 08 |
| 20-15-600 | 3301 | 3301 | 0 | 4.259 | 3301 | 0 | 1 [symbol] .71 [symbol] |
| 20-15-800 | 4321 | 4321 | 0 | 235.098 | 401 | 0.007 | — |
| 20-15-1000 | 5355 | 5355 | 0 | 881.087 | 5355 | 0 | 1016.620 |
| 20-20-800 | 4498 | 4498 | 0 | 715.176 | 44 [symbol] 6 | 0.003 | — |
| 20-20-1000 | 5665 | 445 | 0. [symbol] 21 | — | 365 | [symbol] | — |
| 20-20-1200 | 6767 | 303 | 0. [symbol] 55 | — | 2 [symbol] | 0.045 | — |

[symbol]

indicates data missing or illegible when filed

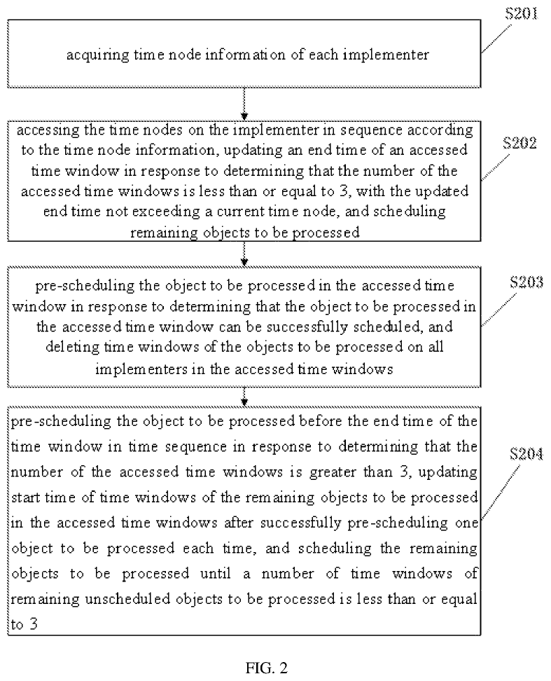

As an optional embodiment, referring to FIG. 2, for the scheduling method for the unrelated parallel machine in the previous embodiment, the time window may also be preprocessed before solving the model.

For the case of no less than four time windows, the time windows can also be preprocessed by a forward rolling time window algorithm, which includes following steps:

S201: acquiring time node information of each implementer;

S202: accessing the time nodes on the implementer in sequence according to the time node information, updating an end time of an accessed time window in response to determining that the number of the accessed time windows is less than or equal to 3, with the updated end time not exceeding a current time node, and scheduling remaining objects to be processed;

S203: pre-scheduling the object to be processed in the accessed time window in response to determining that the object to be processed in the accessed time window can be successfully scheduled, and deleting time windows of the objects to be processed on all implementers in the accessed time windows; and

S204: pre-scheduling the object to be processed before the end time of the time window in time sequence in response to determining that the number of the accessed time windows is greater than 3, updating start time of time windows of the remaining objects to be processed in the accessed time windows after successfully pre-scheduling one object to be processed each time, and scheduling the remaining objects to be processed until a number of time windows of remaining unscheduled objects to be processed is less than or equal to 3.

In this embodiment, for one time window, there is obviously only one case. For any two time windows, there are two cases, let η^{k}ᵢⱼ=pᵢ+pⱼ+Δₖ, where pᵢ and pⱼ represent processing time of the object to be processed, and Δₖ represents the switching time, and overlapping time windows of the objects to be processed I and j are [wsᵢₖ^{l}^{ᵢ}, weᵢₖ^{l}^{ᵢ}], [wsⱼₖ^{l}^{ⱼ}, weⱼₗ^{l}^{ⱼ}].

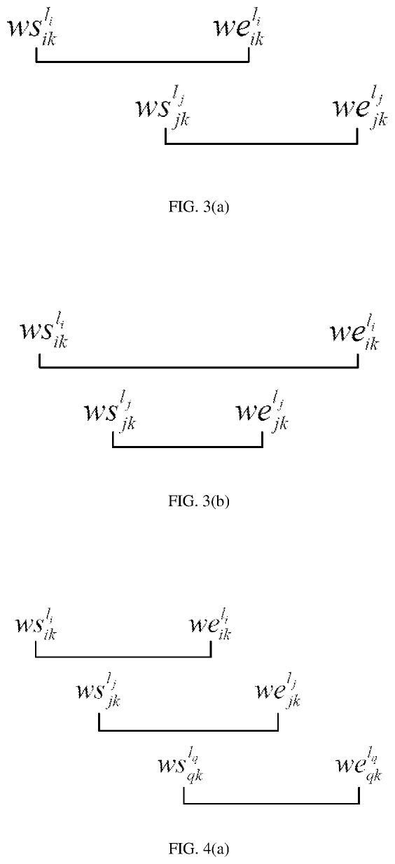

Referring to FIG. 3(a), wsᵢₖ^{l}^{ᵢ}≤wsⱼₖ^{l}^{ⱼ}≤weᵢₖ^{l}^{ᵢ}≤weⱼₖ^{l}^{ⱼ}: if weⱼₖ^{l}^{ⱼ}−wsᵢₖ^{l}^{ᵢ}≥ηijk, the objects I and j to be processed can be successfully scheduled, let the first variable xᵢₖ^{l}^{ᵢ}=xⱼₖ^{l}^{ⱼ}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}.

Referring to FIG. 3(b), wsᵢₖ^{l}^{ᵢ}≤wsⱼₖ^{l}^{ⱼ}≤weⱼₖ^{l}^{ⱼ}≤weᵢₖ^{l}^{ᵢ}, if weⱼₖ^{l}^{ⱼ}−wsᵢₖ^{l}^{ᵢ}≥ηijk, the objects I and j to be processed can be successfully scheduled, let the first variable xᵢₖ^{l}^{ᵢ}=xⱼₖ^{l}^{ⱼ}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}.

If weᵢₖ^{l}^{ᵢ}−wsⱼₖ^{l}^{ⱼ}≥ηijk, the objects I and j to be processed can be successfully scheduled, let the first variable xᵢₖ^{l}^{ᵢ}=xⱼₖ^{l}^{ⱼ}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ.

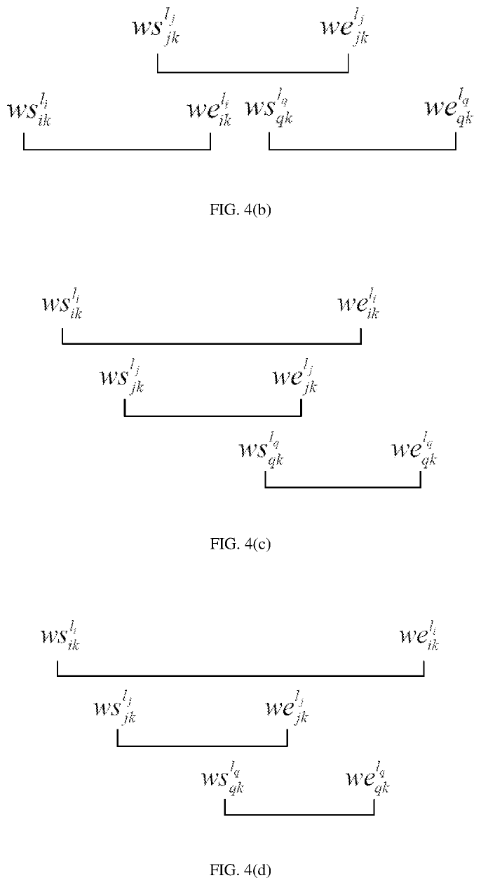

For any three time windows, for three overlapping time windows, [wsᵢₖ^{l}^{ᵢ}, wsᵢₖ^{l}^{ᵢ}], [wsⱼₖ^{l}^{ⱼ}, weⱼₖ^{l}^{ⱼ}] and [ws_{qk}^{l}^{_{q}}, we_{qk}^{l}^{_{q}}] of three objects I, j and q to be processed, and, referring to FIG. 4, there are 10 cases. In order to eliminate symmetry, for all cases, let wsᵢₖ^{l}^{ᵢ}≤wsⱼₖ^{l}^{ⱼ}≤ws_{qk}^{l}^{_{q}}. It is defined η_{ijq}^{k}=pᵢ+pⱼ+p_{q}+2·Δₖ, where pᵢ, pⱼ and p_{q} respectively represent processing time of the objects I, j and q to be processed. In addition, η^{k}ᵢⱼ, η^{k}_{jq} and η^{k}_{iq} are respectively defined as η^{k}ᵢⱼ=pᵢ+pⱼ+Δₖ, η^{k}_{jq}=pⱼ+p_{q}+Δₖ and η^{k}_{iq}=pᵢ+p_{q}+Δₖ. Preprocessing strategies of the three overlapping time windows are different according to different cases.

Referring to FIG. 4(a), in response to determining wsᵢₖ^{l}^{ᵢ}≤wsⱼₖ^{l}^{ⱼ}≤ws_{qk}^{l}^{_{q}}<weᵢₖ^{l}^{ᵢ}≤weⱼₖ^{l}^{ⱼ}≤we_{qk}^{l}^{_{q}}, if we_{qk}^{l}^{_{q}}−wsᵢₖ^{l}^{ᵢ}≥η_{ijq}^{k}, weⱼₖ^{l}^{ⱼ}−wsᵢₖ^{l}^{ᵢ}≥ηijk and we_{qk}^{l}^{_{q}}−wsⱼₖ^{l}^{ⱼ}≥η_{jq}^{k}, the objects I, j and k to be processed can be successfully scheduled, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}.

Referring to FIG. 4(b), in response to determining wsᵢₖ^{l}^{ᵢ}≤weⱼₖ^{l}^{ⱼ}<weᵢₖ^{l}^{ᵢ}≤ws_{qk}^{l}^{_{q}}<weⱼₖ^{l}^{ⱼ}≤we_{qk}^{l}^{_{q}}, if we_{qk}^{l}^{_{q}}−weᵢₖ^{l}^{ᵢ}≥η_{ijq}^{k}, weⱼₖ^{l}^{ⱼ}−wsᵢₖ^{l}^{ᵢ}≥ηijk and we_{qk}^{l}^{_{q}}−weⱼₖ^{l}^{ⱼ}≥η_{jq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}.

Referring to FIG. 4I, in response to determining wsᵢₖ^{l}^{ᵢ}≤wsⱼₖ^{l}^{ⱼ}≤ws_{qk}^{l}^{ⱼ}≤weᵢₖ^{l}^{ᵢ}<we_{qk}^{l}^{_{q}} and we_{qk}^{l}^{_{q}}−weᵢₖ^{l}^{ᵢ}≥η_{ijq}^{k}, if weⱼₖ^{l}^{ⱼ}−wsᵢₖ^{l}^{ᵢ}≥ηijk and we_{qk}^{l}^{_{q}}−max{weᵢₖ^{l}^{ᵢ}+pᵢ+Δₖ, weⱼₖ^{l}^{ⱼ}}≥η_{jq}^{k}, let the first variable xᵢⱼ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, tⱼₖ^{l}^{ⱼ}=max{tⱼₖ^{l}^{ⱼ}+pⱼ+Δₖ, we_{qk}^{l}^{_{q}}}; and if weⱼₖ^{l}^{ⱼ}−wsᵢₖ^{l}^{ᵢ}≥ηijk and we_{qk}^{l}^{_{q}}−weⱼₖ^{l}^{ⱼ}≥η_{ijq}^{k}, let the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, ws_{qk}^{l}^{_{q}}}.

Referring to FIG. 4(d), in response to determining wsᵢₖ^{l}^{ᵢ}≤wsⱼₖ^{l}^{ⱼ}≤ws_{qk}^{l}^{_{q}}<weⱼₖ^{l}^{ⱼ}<we_{qk}^{l}^{_{q}}≤weᵢₖ^{l}^{ᵢ} and weᵢₖ^{l}^{ᵢ}−wsᵢₖ^{l}^{ᵢ}≥η_{ijq}^{k}, if we_{qk}^{l}^{_{q}}−wsⱼₖ^{l}^{ⱼ}≥η_{jq}^{k} and we_{qk}^{l}^{_{q}}−wsᵢₖ^{l}^{ᵢ}≥η_{ijq}^{k} and weⱼₖ^{l}^{ⱼ}−wsᵢₖ^{l}^{ᵢ}≥ηijk, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}; if we_{qk}^{l}^{_{q}}−wsⱼₖ^{l}^{ⱼ}≥η_{jq}^{k} and weᵢₖ^{l}^{ᵢ}−ws_{qk}^{l}^{_{q}}≥η_{iq}^{k}, and weᵢₖ^{l}^{ᵢ}−ws_{qk}^{l}^{_{q}}≥η_{iq}^{k}, let the first variable xᵢₖ^{l}^{ᵢ}−wsⱼₖ^{l}^{ⱼ}=x_{qk}^{l}^{_{q}}=1 and the second variable tⱼₖ^{l}^{ⱼ}=wsⱼₖ^{l}^{ⱼ}, t_{qk}^{l}^{_{q}}=max{tⱼₖ^{l}^{ⱼ}+pⱼ+Δₖ, we_{qk}^{l}^{_{q}}}, tᵢₖ^{l}^{ᵢ}=t_{qk}^{l}^{_{q}}+p_{q}+Δₖ; and if we_{qk}^{l}^{_{q}}−wsⱼₖ^{l}^{ⱼ}≥η_{ijq}^{k}, let the first variable xᵢₖ^{l}^{ᵢ}=x_{jq}^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, ws_{qk}^{l}^{_{q}}}.

Referring to FIG. 4I, in response to determining wsᵢₖ^{l}^{ᵢ}≤wsⱼₖ^{l}^{ⱼ}≤ws_{qk}^{l}^{_{q}}<weᵢₖ^{l}^{ᵢ}≤we_{qk}^{l}^{_{q}} and we_{qk}^{l}^{_{q}}−wsᵢₖ^{l}^{ᵢ}≥η_{ijq}^{k}, if weⱼₖ^{l}^{ⱼ}−wsᵢₖ^{l}^{ᵢ}≥ηijk, let the first variable xᵢⱼ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=ws_{qk}^{l}^{_{q}}; and if weᵢₖ^{l}^{ᵢ}−wsⱼₖ^{l}^{ⱼ}≥ηijk and we_{qk}^{l}^{_{q}}−wsⱼₖ^{l}^{ⱼ}≥η_{ijq}^{k}, let the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, we_{qk}^{l}^{_{q}}}.

Referring to FIG. 4(f), in response to determining wsᵢₖ^{l}^{ᵢ}≤wsⱼₖ^{l}^{ⱼ}<weᵢₖ^{l}^{ᵢ}≤ws_{qk}^{l}^{_{q}}<we_{qk}^{l}^{_{q}}≤weⱼₖ^{l}^{ⱼ} and weⱼₖ^{l}^{ⱼ}−wsᵢₖ^{l}^{ᵢ}≥η_{ijq}^{k}, if weⱼₖ^{l}^{ⱼ}−ws_{qk}^{l}^{_{q}}≥η_{jq}^{k}, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=ws_{qk}^{l}^{_{q}}, tⱼₖ^{l}^{ⱼ}=t_{qk}^{l}^{_{q}}+p_{q}+Δₖ; and if we_{qk}^{l}^{_{q}}−wsⱼₖ^{l}^{ⱼ}≥η_{jq}^{k} and we_{qk}^{l}^{_{q}}−wsᵢₖ^{l}^{ᵢ}≥η_{ijq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, t_{qk}^{l}^{_{q}}=max{tⱼₖ^{l}^{ⱼ}+pⱼ+Δₖ, we_{qk}^{l}^{_{q}}}.

Referring to FIG. 4(g), in response to determining wsᵢₖ^{l}^{ᵢ}≤wsⱼₖ^{l}^{ⱼ}<weⱼₖ^{l}^{ⱼ}≤we_{qk}^{l}^{_{q}}<we_{qk}^{l}^{_{q}}≤weᵢₖ^{l}^{ᵢ} and weᵢₖ^{l}^{ᵢ}−weᵢₖ^{l}^{ᵢ}≥η_{ijq}^{k}, if weⱼₖ^{l}^{ⱼ}−wsᵢₖ^{l}^{ᵢ}≥ηijk, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=ws_{qk}^{l}^{_{q}}, tⱼₖ^{l}^{ⱼ}=max{tᵢₖ^{l}^{ᵢ}+pᵢ+Δₖ, weⱼₖ^{l}^{ⱼ}}; if weᵢₖ^{l}^{ᵢ}−ws_{qk}^{l}^{_{q}}≥η_{iq}^{k}, let the first variable xᵢₖ^{l}^{ᵢ}=xⱼₖ^{l}^{ⱼ}=x_{qk}^{l}^{_{q}}=1 and the second variable t_{qk}^{l}^{_{q}}=ws_{qk}^{l}^{_{q}}, tⱼₖ^{l}^{ⱼ}=wsⱼₖ^{l}^{ⱼ}, tᵢₖ^{l}^{ᵢ}=t_{qk}^{l}^{_{q}}+p_{q}+Δₖ; and if we_{qk}^{l}^{_{q}}−wsⱼₖ^{l}^{ⱼ}≥η_{ijq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=tⱼₖ^{l}^{ⱼ}+pⱼ+Δₖ, tⱼₖ^{l}^{ⱼ}=wsⱼₖ^{l}^{ⱼ}, t_{qk}^{l}^{_{q}}={tᵢₖ^{l}^{ᵢ}+pᵢ+Δₖ, ws_{qk}^{l}^{_{q}}}.

Referring to FIG. 4(h), in response to determining wsᵢₖ^{l}^{ᵢ}<wsⱼₖ^{l}^{ⱼ}≤ws_{qk}^{l}^{_{q}}<weᵢₖ^{l}^{ᵢ}≤we_{qk}^{l}^{_{q}}≤weⱼₖ^{l}^{ⱼ} and weⱼₖ^{l}^{ⱼ}−wsᵢₖ^{l}^{ᵢ}≥η_{ijq}^{k}, if weⱼₖ^{l}^{ⱼ}−max{wsᵢₖ^{l}^{ᵢ}+pᵢ+Δₖ, we_{qk}^{l}^{_{q}}}≥η_{jq}^{k}, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, we_{qk}^{l}^{_{q}}}, tⱼₖ^{l}^{ⱼ}=t_{qk}^{l}^{_{q}}+p_{q}+Δₖ; and if we_{qk}^{l}^{_{q}}−max{wsᵢₖ^{l}^{ᵢ}+pᵢ+Δₖ, wsⱼₖ^{l}^{ⱼ}}≥η_{jq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}.

Referring to FIG. 4(i), in response to determining wsᵢₖ^{l}^{ᵢ}≤wsⱼₖ^{l}^{ⱼ}≤ws_{qk}^{l}^{_{q}}<we_{qk}^{l}^{_{q}}≤weⱼₖ^{l}^{ⱼ}≤weᵢₖ^{l}^{ᵢ} and weᵢₖ^{l}^{ᵢ}−wsᵢₖ^{l}^{ᵢ}≥η_{ijq}^{k}, if we_{qk}^{l}^{_{q}}−wsᵢₖ^{l}^{ᵢ}≥η_{ijq}^{k} and we_{qk}^{l}^{_{q}}−wsⱼₖ^{l}^{ⱼ}≥η_{jq}^{k}, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}; if weⱼₖ^{l}^{ⱼ}−wsᵢₖ^{l}^{ᵢ}≥η_{ijq}^{k} and weⱼₖ^{l}^{ⱼ}−max{wsᵢₖ^{l}^{ᵢ}+pᵢ+Δₖ, ws_{qk}^{l}^{_{q}}}≥η_{jq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, ws_{qk}^{l}^{_{q}}}, tⱼₖ^{l}^{ⱼ}=t_{qk}^{l}^{_{q}}+p_{q}+Δₖ; if we_{qk}^{l}^{_{q}}−wsⱼₖ^{l}^{ⱼ}≥η_{jq}^{k} and weᵢₖ^{l}^{ᵢ}−max{wsⱼₖ^{l}^{ⱼ}+pⱼ+Δₖ, ws_{qk}^{l}^{_{q}}}≥η_{iq}^{k}, let the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, t_{qk}^{l}^{_{q}}=max{tⱼₖ^{l}^{ⱼ}+pⱼ+Δₖ, ws_{qk}^{l}^{_{q}}}, tᵢₖ^{l}^{ᵢ}=t_{qk}^{l}^{_{q}}+p_{q}+Δₖ; and if weᵢₖ^{l}^{ᵢ}−ws_{qk}^{l}^{_{q}}≥η_{ijq}^{k} and weⱼₖ^{l}^{ⱼ}−ws_{qk}^{l}^{_{q}}≥η_{jq}^{k}, let the first variable xᵢₖ^{l}^{ᵢ}=xⱼₖ^{l}^{ⱼ}=x_{qk}^{l}^{_{q}}=1 and the second variable tⱼₖ^{l}^{ⱼ}=t_{qk}^{l}^{_{q}}+p_{q}+Δₖ, t_{qk}^{l}^{_{q}}=ws_{qk}^{l}^{_{q}}, tᵢₖ^{l}^{ᵢ}=tⱼₖ^{l}^{ⱼ}+pⱼ+Δₖ.

Referring to FIG. 4(j), in response to determining wsᵢₖ^{l}^{ᵢ}≤wsⱼₖ^{l}^{ⱼ}≤ws_{qk}^{l}^{_{q}}<we_{qk}^{l}^{_{q}}≤weᵢₖ^{l}^{ᵢ}<weⱼₖ^{l}^{ⱼ} and weⱼₖ^{l}^{ⱼ}−wsᵢₖ^{l}^{ᵢ}≥η_{ijq}^{k}, if we_{qk}^{l}^{_{q}}−wsᵢₖ^{l}^{ᵢ}≥η_{ijq}^{k} and we_{qk}^{l}^{_{q}}−wsⱼₖ^{l}^{ⱼ}≥η_{jq}^{k}, let the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, t_{qk}^{l}^{_{q}}=max{tⱼₖ^{l}^{ⱼ}+p_{q}+Δₖ, ws_{qk}^{l}^{_{q}}}; if we_{qk}^{l}^{_{q}}−wsᵢₖ^{l}^{ᵢ}≥η_{ijq}^{k} and weⱼₖ^{l}^{ⱼ}−ws_{qk}^{l}^{_{q}}≥η_{jq}^{k}, let the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, ws_{qk}^{l}^{_{q}}}, tⱼₖ^{l}^{ⱼ}=t_{qk}^{l}^{_{q}}+p_{q}+Δₖ; and if weᵢₖ^{l}^{ᵢ}−ws_{qk}^{l}^{_{q}}≥η_{iq}^{k} and weⱼₖ^{l}^{ⱼ}−ws_{qk}^{l}^{_{q}}≥η_{ijq}^{k}, let the first variable xᵢₖ^{l}^{ᵢ}=xⱼₖ^{l}^{ⱼ}=x_{qk}^{l}^{_{q}}=1 and the second variable t_{qk}^{l}^{_{q}}=ws_{qk}^{l}^{_{q}}, tᵢₖ^{l}^{ᵢ}=t_{qk}^{l}^{_{q}}+p_{q}+Δₖ, tⱼₖ^{l}^{ⱼ}=tᵢₖ^{l}^{ᵢ}+pᵢ+Δₖ.

In this embodiment, a flow of the forward rolling time window algorithm is referenced in the following. By preprocessing for different cases for multiple time windows, the problem size can be reduced and the solving efficiency can be improved.

Algorithm 2: Forward-Rolling-Horizon

| 1 | TWS ← 0 [symbol] // the set of time windows in the current time interval [symbol] | | | | | | |
|---|---|---|---|---|---|---|---|
| 2 | EJobs ← 0 [symbol] // the set of eligible jobs that can be pre-scheduled; | | | | | | |
| 3 | for each time node [symbol] t ∈ TN in [symbol] ascending order do | | | | | | |
| 4 | \| | if [symbol] is the first time node of a time interval then | | | | | |
| 5 | \| | \|_{—} | TWS ← TWS ∪ [symbol] ᵢₖ [symbol] | | | | |
| 6 | \| | else | | | | | |
| 7 | \| | \| | if [symbol] TWS [symbol] ≤ 3 then | | | | |
| 8 | \| | \| | \| | w [symbol] ᵢₖ = min [symbol] we [symbol] ᵢₖ [symbol] , [symbol] w [symbol] ᵢₖ ∈ TWS; | | | |
| 9 | \| | \| | \| | if weᵢₖ [symbol] − wsᵢₖ [symbol] ≥ pᵢ + Δₖ, [symbol] w [symbol] ᵢₖ ∈ TWS and jobs in TWS can be | | | |
| | \| | \| | \| | scheduled according to the situations in subsection 4.2 then | | | |
| 10 | \| | \| | \| | \| | Schedule both the jobs TWS and the jobs EJobs | | |
| 11 | \| | \| | \| | \|_{—} | return IsReboot = 1; | | |
| | | | \|_{—} | | | | |
| 12 | \| | \| | else | | | | |
| 13 | \| | \| | \| | Succ − 0, beginTime ← 0 [symbol] | | | |
| 14 | \| | \| | \| | [symbol] = min [symbol] [symbol] [symbol] ∈ TWS: | | | |
| 15 | \| | \| | \| | if Succ = 0 then | | | |
| 16 | \| | \| | \| | \| | sort the time windows in TWS in an ascending order of the start | | |
| | \| | \| | \| | \|_{—} | times; | | |
| 17 | \| | \| | \| | else | | | |
| 18 | \| | \| | \| | \| | sort the time windows in TWS in an ascending order of the finish | | |
| | \| | \| | \| | \|_{—} | times [symbol] | | |
| 19 | \| | \| | \| | for each time window [symbol] of the first [symbol] TWS [symbol] − 3 time windows do | | | |
| 20 | \| | \| | \| | \| | if [symbol] + pᵢ Δₖ ≤ [symbol] then | | |
| 21 | \| | \| | \| | \| | \| | beginTime [symbol] max [symbol] beginTime, [symbol] + pᵢ + Δₖ [symbol] | |
| 22 | \| | \| | \| | \| | \| | EJobs ← EJobs ∪ [symbol] | |
| 23 | \| | \| | \| | \| | \| | TWS ← TWS\ [symbol] | |
| 24 | \| | \| | \| | \| | \| | for each time window t [symbol] ⱼₖ [symbol] ∈ TWS do | |
| 25 | \| | \| | \| | \| | \| | \|_{—} | [symbol] sⱼₖ [symbol] ← max [symbol] sⱼₖ [symbol] ,beginTime [symbol] ; |

| 26 | \| | \| | \| | \| | else | |
|---|---|---|---|---|---|---|
| 27 | \| | \| | \| | \| | \|_{—} | break [symbol] |

| | \| | \| | \| | \|_{—} | |
|---|---|---|---|---|---|
| 28 | \| | \| | \| | if [symbol] TWS [symbol] ≤ 3 and jobs in TWS can be pre-scheduled then | |
| 29 | \| | \| | \| | \| | Schedule both the jobs in TWS and the jobs in EJobs [symbol] |
| 30 | \| | \| | \| | \|_{—} | return IsReboot = 1; |
| 31 | \| | \| | \| | else if Succ = 0 then | |
| 32 | \| | \| | \|_{—} | \|_{—} | Succ = 1, EJobs [symbol] 0, goto line 15; |

| 33 | \| | \| | if [symbol] is the beginning time of a time window [symbol] (of job i) then | |
|---|---|---|---|---|
| 34 | \| | \| | \|_{—} | TWS ← TWS ∪ t [symbol] ᵢₖ [symbol] |
| 35 | \| | \| | else if t is the last time node of the current interval then | |
| 36 | \| | \| | \|_{—} | TWS ← 0, EJobs ← 0; |

| | |
|---|---|
| \| | \|_{—} |

| | |
|---|---|
| | \|_{—} |
| 37 | return IsReboot = 0 [symbol] |

[symbol]

indicates data missing or illegible when filed

As a specific embodiment, the performance of this preprocessing algorithm is tested by comparing with a preprocessing strategy of Chen et al. At first, “Our preprocessing I” in table 3 represents the preprocessing algorithm proposed in this embodiment, and “Our preprocessing II” represents combination of the preprocessing algorithm in this embodiment and the preprocessing algorithm of Chen et al. Table 5 lists the comparison results, where “Num” is a number of scheduled objects to be processed in preprocessing. “Objective” and “Time(s)” respectively represent the total profit of pre-scheduling the objects to be processed and the solution time of the pre-processing.

From the results in Table 3, it can be observed that the number of pre-scheduled objects to be processed in the pre-processing strategies I and II of this embodiment is always greater than or equal to the number of pre-scheduled objects to be processed by Chen et al. In addition, for most instances (34 out of 47), the number of pre-scheduled objects to be processed is larger than that of Chen et al., which is marked in bold. Therefore, compared with the algorithm of Chen et al., the algorithm in this embodiment has a great improvement in preprocessing. In addition, regarding the preprocessing strategies I and II of this embodiment, the number of objects to be processed is the same in all instances. Therefore, it is concluded that the solution time of preprocessing algorithm II in this embodiment is shorter than that of preprocessing algorithm I, which is marked in bold, and combination of the two algorithms plays an important role in improving efficiency of the preprocessing algorithm.

In some embodiments, referring to the following flow, the time window can also be preprocessed by a backward rolling time window algorithm, and steps of the backward rolling time window algorithm are similar to those of the forward rolling time window algorithm, except that an order of accessing time nodes is reversed and from back to front. Therefore, the backward rolling time window algorithm can be regarded as mirroring of the forward rolling time window algorithm, that is, the start time of the time window becomes the end time of the time window, and the end time of the time window becomes the start time of the time window.

Algorithm 3: Backward-Rilling-Horizon

| 1 | TWS ← 0 [symbol] // the set of time windows in the current time interval [symbol] | | | | | | |
|---|---|---|---|---|---|---|---|
| 2 | EJobs ← 0 [symbol] // the set of eligible jobs that can be pre-scheduled [symbol] | | | | | | |
| 3 | for each time node [symbol] ∈ TN in a descending order do | | | | | | |
| 4 | \| | if t is the last time node of a time interval then | | | | | |
| 5 | \| | \|_{—} | TWS ← TWS ∪ t [symbol] | | | | |
| 6 | \| | else | | | | | |
| 7 | \| | \| | if [symbol] TWS [symbol] ≤ 3 then | | | | |
| 8 | \| | \| | \| | [symbol] = max [symbol] , [symbol] ᵢₖ [symbol] ∈ TWS | | | |
| 9 | \| | \| | \| | if [symbol] − [symbol] ≥ pᵢ + Δₖ, [symbol] ∈ TWS and jobs in TWS can be | | | |
| | \| | \| | \| | scheduled according to the situations in subsection 4.2 then | | | |
| 10 | \| | \| | \| | \| | Schedule both the jobs in TWS and the jobs in EJobs [symbol] | | |
| 11 | \| | \| | \| | \|_{—} | return IsReboot = 1 [symbol] | | |
| | \| | \| | \|_{—} | | | | |
| 12 | \| | \| | else | | | | |
| 13 | \| | \| | \| | Succ [symbol] 0, finishTime [symbol] T [symbol] | | | |
| 14 | \| | \| | \| | [symbol] = max [symbol] ∈ TWS; | | | |
| 15 | \| | \| | \| | if Succ = 0 then | | | |
| 16 | \| | \| | \| | \| | sort the time windows in TWS in a descending order of the finish | | |
| | \| | \| | \| | \|_{—} | times [symbol] | | |
| 17 | \| | \| | \| | else | | | |
| 18 | \| | \| | \| | \| | sort the time windows in TWS in a descending order of the | | |
| | \| | \| | \| | \|_{—} | beginning times; | | |
| 19 | \| | \| | \| | for each time window [symbol] of the first [symbol] TWS [symbol] − 3 time windows do | | | |
| 20 | \| | \| | \| | \| | if [symbol] ᵢₖ [symbol] − pᵢ − Δₖ ≥ [symbol] ᵢₖ [symbol] then | | |
| 21 | \| | \| | \| | \| | \| | finishTime ← min [symbol] finishTime, [symbol] ᵢₖ [symbol] − pᵢ − Δₖ [symbol] | |
| 22 | \| | \| | \| | \| | \| | EJobs ← EJobs ∪ [symbol] | |
| 23 | \| | \| | \| | \| | \| | TWS ← TWS\ [symbol] ᵢₖ [symbol] | |
| 24 | \| | \| | \| | \| | \| | for each time window t [symbol] ⱼₖ [symbol] ∈ TWS do | |
| 25 | \| | \| | \| | \| | \| | \|_{—} | [symbol] ⱼₖ [symbol] ← min [symbol] , finishTime [symbol] |

| | \| | \| | \| | \| | \|_{—} | |
|---|---|---|---|---|---|---|
| 26 | \| | \| | \| | \| | else | |
| 27 | \| | \| | \| | \| | \|_{—} | break [symbol] |

| | \| | \| | \| | \|_{—} | |
|---|---|---|---|---|---|
| 28 | \| | \| | \| | if [symbol] TWS [symbol] ≤ 3 jobs in TWS can be pre-scheduled then | |
| 29 | \| | \| | \| | \| | Schedule both the jobs in TWS and the jobs EJobs [symbol] |
| 30 | \| | \| | \| | \|_{—} | return IsReboot = 1; |
| 31 | \| | \| | \| | else if Succ = 0 then | |
| 32 | \| | \| | \| | \|_{—} | Succ = 1, EJobs ← 0, goto line 15 [symbol] |

| | | | \|_{—} | |
|---|---|---|---|---|
| 33 | \| | \| | if t is the finish time of a time window t [symbol] (of job i) then | |
| 34 | \| | \| | \|_{—} | TWS ← TWS ∪ t [symbol] ᵢₖ [symbol] |
| 35 | \| | \| | else if t is the first time node of the current interval then | |
| 36 | \| | \| | \|_{—} | TW S ← 0, EJobs ← 0; |

| | |
|---|---|
| \| | \|_{—} |

| | |
|---|---|
| | \|_{—} |
| 37 | return IsReboot = 0 [symbol] |

[symbol]

indicates data missing or illegible when filed

As an optional embodiment, for the model in the previous embodiment, the non-dominant inequality can also be obtained according to the overlapping information of all the time windows, and the non-dominant inequality can be added to the model, which includes following steps:

When the number of overlapping time windows is two, let η^{k}ᵢⱼ=pᵢ+pⱼ+Δₖ, where pᵢ and pⱼ represent processing time of the objects to be processed I and j, and Δₖ represents the switching time, and the overlapping time windows of the objects I and j to be processed are [wsᵢₖ^{l}^{ᵢ}, weᵢₖ^{l}^{ᵢ}], [wsⱼₖ^{l}^{ⱼ}, weⱼₖ^{l}^{ⱼ}];

Referring to FIG. 3(a), in response to determining weᵢₖ^{l}^{ᵢ}−weⱼₖ^{l}^{ⱼ}<ηijk, an inequality is obtained: xᵢₖ^{l}^{ᵢ}+xⱼₖ^{l}^{ⱼ}<=1.

Referring to FIG. 3(b), in response to determining weⱼₖ^{l}^{ⱼ}−wsᵢₖ^{l}^{ᵢ}<ηijk, weᵢₖ^{l}^{ᵢ}−wsⱼₖ^{l}^{ⱼ}<ηijk, an inequality is obtained: xᵢₖ^{l}^{ᵢ}+xⱼₖ^{l}^{ⱼ}<=1.

According to the obtained inequality, the non-dominant inequality can be obtained.

As an optional embodiment, for step S104 in the previous embodiment, the obtaining the non-dominant inequality according to the overlapping information of all the time windows further includes the following.

When the number of the overlapping time windows is three, let η^{k}ᵢⱼ=pᵢ+pⱼ+p_{q}+2·Δₖ, η^{k}ᵢⱼ=pᵢ+pⱼ+Δₖ, η^{k}_{jq}=pⱼ+p_{q}+Δₖ, η^{k}_{iq}=pᵢ+p_{q}+Δₖ, where pᵢ, pⱼ and p_{q} represent the objects I, j and q to be processed respectively, Δₖ represents the switching time, the three overlapping time windows of the objects I, j and q to be processed are: [wsᵢₖ^{l}^{ᵢ}, weᵢₖ^{l}^{ᵢ}], [wsⱼₖ^{l}^{ⱼ}, weⱼₖ^{l}^{ⱼ}] and [ws_{qk}^{l}^{_{q}}, we_{qk}^{l}^{_{q}}], Φ (a, b, P) represents a maximum number of objects to be processed that can be scheduled in a candidate object set P in a time interval [a, b]; in this embodiment, for three objects to be processed and the candidate object set P={I, j, q}, the maximum number of objects to be processed that can be scheduled Φ (a, b, P) can be obtained by: processing each object to be processed one by one in an ascending order of the processing time in the time interval [a, b] until the processing time exceeds the time interval [a, b], and taking a number of objects to be processed which are processed in the time interval [a, b] as the number of objects to be processed Φ (a, b, P).

Referring to FIG. 4(a), in response to determining weᵢₖ^{l}^{ᵢ}≤wsⱼₖ^{l}^{ⱼ}≤ws_{qk}^{l}^{_{q}}<weᵢₖ^{l}^{ᵢ}≤weⱼₖ^{l}^{ⱼ}≤we_{qk}^{l}^{_{q}}, if we_{qk}^{l}^{_{q}}−weᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, we_{qk}^{l}^{_{q}}, P) is obtained.

Referring to FIG. 4(b), in response to determining wsᵢₖ^{l}^{ᵢ}≤wsⱼₖ^{l}^{ⱼ}<weᵢₖ^{l}^{ᵢ}≤ws_{qk}^{l}^{_{q}}<weⱼₖ^{l}^{ⱼ}≤we_{qk}^{l}^{_{q}}, if we_{qk}^{l}^{_{q}}−wsᵢₖ^{l}^{ᵢ}<η_{iq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, we_{qk}^{l}^{_{q}}, P is obtained.

Referring to FIG. 4I, in response to determining wsᵢₖ^{l}^{ᵢ}≤wsⱼₖ^{l}^{ⱼ}≤ws_{qk}^{l}^{_{q}}<weⱼₖ^{l}^{ⱼ}≤weᵢₖ^{l}^{ᵢ}<we_{qk}^{l}^{_{q}}, if we_{qk}^{l}^{_{q}}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, we_{qk}^{l}^{_{q}}, P) is obtained; Otherwise, we_{qk}^{l}^{_{q}}−wsⱼₖ^{l}^{ⱼ}<η_{ijq}^{k} and weⱼₖ^{l}^{ⱼ}−wsᵢₖ^{l}^{ᵢ}<ηijk, an inequality xᵢₖ^{l}^{ᵢ}+xⱼₖ^{l}^{ⱼ}+x_{qk}^{l}^{_{q}}≤2 is obtained.

Referring to FIG. 4(d), in response to determining wsᵢₖ^{l}^{ᵢ}≤wsⱼₖ^{l}^{ⱼ}≤ws_{qk}^{l}^{_{q}}<weⱼₖ^{l}^{ⱼ}<we_{qk}^{l}^{_{q}}≤weᵢₖ^{l}^{ᵢ}, if weᵢₖ^{l}^{ᵢ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, weᵢₖ^{l}^{ᵢ}, P) is obtained; Otherwise, if we_{qk}^{l}^{_{q}}−wsᵢₖ^{l}^{ᵢ}<η_{ijq}^{k} and weᵢₖ^{l}^{ᵢ}−wsⱼₖ^{l}^{ⱼ}<η_{ijq}^{k}, an inequality xᵢₖ^{l}^{ᵢ}+xⱼₖ^{l}^{ⱼ}+x_{qk}^{l}^{_{q}}≤max{Φ(wsᵢₖ^{l}^{ᵢ}, we_{qk}^{l}^{_{q}}, P), Φ(wsⱼₖ^{l}^{ⱼ}, weᵢₖ^{l}^{ᵢ}, P)} is obtained; If we_{qk}^{l}^{_{q}}−wsᵢₖ^{l}^{ᵢ}≥η_{ijq}^{k}, weᵢₖ^{l}^{ᵢ}−wsⱼₖ^{l}^{ⱼ}<η_{ijq}^{k}, we_{qk}^{l}^{_{q}}−weⱼₖ^{l}^{ⱼ}>p_{q}+Δₖ and weⱼₖ^{l}^{ⱼ}−wsᵢₖ^{l}^{ᵢ}<ηijk or we_{qk}^{l}^{_{q}}−wsᵢₖ^{l}^{ᵢ}<η_{ijq}^{k}, weᵢₖ^{l}^{ᵢ}−wsⱼₖ^{l}^{ⱼ}≥η_{ijq}^{k}, we_{qk}^{l}^{_{q}}−weⱼₖ^{l}^{ⱼ}>pⱼ+Δₖ and weᵢₖ^{l}^{ᵢ}−ws_{qk}^{l}^{_{q}}<η_{iq}^{k} or we_{qk}^{l}^{_{q}}−wsᵢₖ^{l}^{ᵢ}≥η_{ijq}^{k}, weᵢₖ^{l}^{ᵢ}−wsⱼₖ^{l}^{ⱼ}≥η_{ijq}^{k}, we_{qk}^{l}^{_{q}}−weⱼₖ^{l}^{ⱼ}>p_{q}+Δₖ, weⱼₖ^{l}^{ⱼ}−wsᵢₖ^{l}^{ᵢ}<ηijk, ws_{qk}^{l}^{_{q}}−wsⱼₖ^{l}^{ⱼ}>pⱼ+Δₖ and weⱼₖ^{l}^{ⱼ}−ws_{qk}^{l}^{_{q}}<η_{iq}^{k}, an inequality xᵢₖ^{l}^{ᵢ}+xⱼₖ^{l}^{ⱼ}+x_{qk}^{l}^{_{q}}≤2 is obtained.

Referring to FIG. 4I, in response to determining wsᵢₖ^{l}^{ᵢ}≤wsⱼₖ^{l}^{ⱼ}<weⱼₖ^{l}^{ⱼ}≤ws_{qk}^{l}^{_{q}}<weᵢₖ^{l}^{ᵢ}≤we_{qk}^{l}^{_{q}}, if we_{qk}^{l}^{_{q}}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, we_{qk}^{l}^{_{q}}, P) is obtained; Otherwise, if we_{qk}^{l}^{_{q}}−wsⱼₖ^{l}^{ⱼ}<η_{ijq}^{k} and weⱼₖ^{l}^{ⱼ}−wsᵢₖ^{l}^{ᵢ}<ηijk, an inequality xᵢₖ^{l}^{ᵢ}+xⱼₖ^{l}^{ⱼ}+x_{qk}^{l}^{_{q}}≤2 is obtained.

Referring to FIG. 4(f), in response to determining wsᵢₖ^{l}^{ᵢ}≤wsⱼₖ^{l}^{ⱼ}<weᵢₖ^{l}^{ᵢ}≤ws_{qk}^{l}^{_{q}}<we_{qk}^{l}^{_{q}}≤weⱼₖ^{l}^{ⱼ}, if weⱼₖ^{l}^{ⱼ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, weⱼₖ^{l}^{ⱼ}, P) is obtained; otherwise, if we_{qk}^{l}^{_{q}}−wsᵢₖ^{l}^{ᵢ}<η_{ijq}^{k} and weⱼₖ^{l}^{ⱼ}−ws_{qk}^{l}^{_{q}}<η_{jq}^{k}, an inequality xᵢₖ^{l}^{ᵢ}+xⱼₖ^{l}^{ⱼ}+x_{qk}^{l}^{_{q}}≤2 is obtained.

Referring to FIG. 4(g), in response to determining wsᵢₖ^{l}^{ᵢ}≤wsⱼₖ^{l}^{ⱼ}<wsⱼₖ^{l}^{ⱼ}≤ws_{qk}^{l}^{_{q}}<we_{qk}^{l}^{_{q}}≤weᵢₖ^{l}^{ᵢ}, if weᵢₖ^{l}^{ᵢ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}<ηijk and we_{qk}^{l}^{_{q}}−wsⱼₖ^{l}^{ⱼ}<η_{ijq}^{k}, an inequality xᵢₖ^{l}^{ᵢ}+xⱼₖ^{l}^{ⱼ}+x_{qk}^{l}^{_{q}}≤2 is obtained.

Referring to FIG. 4(h), in response to determining wsᵢₖ^{l}^{ᵢ}<wsⱼₖ^{l}^{ⱼ}≤ws_{qk}^{l}^{_{q}}<weᵢₖ^{l}^{ᵢ}≤we_{qk}^{l}^{_{q}}≤weⱼₖ^{l}^{ⱼ}, if weⱼₖ^{l}^{ⱼ}−weᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, weⱼₖ^{l}^{ⱼ}, P) is obtained; otherwise, if we_{qk}^{l}^{_{q}}−wsᵢₖ^{l}^{ᵢ}<η_{ijq}^{k} and weⱼₖ^{l}^{ⱼ}−ws_{qk}^{l}^{_{q}}<η_{jq}^{k}, an inequality xᵢₖ^{l}^{ᵢ}+xⱼₖ^{l}^{ⱼ}+x_{qk}^{l}^{_{q}}≤2 is obtained.

Referring to FIG. 4(i), in response to determining wsᵢₖ^{l}^{ᵢ}≤wsⱼₖ^{l}^{ⱼ}≤ws_{qk}^{l}^{_{q}}<we_{qk}^{l}^{_{q}}≤weⱼₖ^{l}^{ⱼ}≤weᵢₖ^{l}^{ᵢ}, if weᵢₖ^{l}^{ᵢ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(wsᵢₖ^{l}^{ᵢ}, weᵢₖ^{l}^{ᵢ}, P) is obtained.

Otherwise, if weᵢₖ^{l}^{ᵢ}−wsⱼₖ^{l}^{ⱼ}<η_{ijq}^{k} and weⱼₖ^{l}^{ⱼ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤max{ϕ(wsᵢₖ^{l}^{ᵢ}, weⱼₖ^{l}^{ⱼ}, P), ϕ(wsⱼₖ^{l}^{ⱼ}, weᵢₖ^{l}^{ᵢ}, P)} is obtained;

If weᵢₖ^{l}^{ᵢ}−wsⱼₖ^{l}^{ⱼ}<η_{ijq}^{k} and weⱼₖ^{l}^{ⱼ}−wsᵢₖ^{l}^{ᵢ}≥η_{ijq}^{k},

If we_{qk}^{l}^{_{q}}−wsᵢₖ^{l}^{ᵢ}<η_{ijq}^{k} and weⱼₖ^{l}^{ⱼ}−ws_{qk}^{l}^{_{q}}<η_{jq}^{k}, an inequality xᵢₖ^{l}^{ᵢ}+xⱼₖ^{l}^{ⱼ}+x_{qk}^{l}^{_{q}}≤2 is obtained,

If wsᵢₖⁱ+pᵢ+Δₖ≥ws_{qk}^{l}^{_{q}} and we_{qk}^{l}^{_{q}}−wsᵢₖ^{l}^{ᵢ}<η_{iq}^{k}, an inequality xᵢₖ^{l}^{ᵢ}+xⱼₖ^{l}^{ⱼ}+x_{qk}^{l}^{_{q}}≤2 is obtained;

If weᵢₖ^{l}^{ᵢ}−wsⱼₖ^{l}^{ⱼ}≥η_{ijq}^{k} and weⱼₖ^{l}^{ⱼ}−wsᵢₖ^{l}^{ᵢ}<η_{ijq}^{k},

If weᵢₖ^{l}^{ᵢ}−ws_{qk}^{l}^{_{q}}<η_{ijq}^{k} and we_{qk}^{l}^{_{q}}−wsⱼₖ^{l}^{ⱼ}<η_{jq}^{k}, an inequality xᵢₖ^{l}^{ᵢ}+xⱼₖ^{l}^{ⱼ}+x_{qk}^{l}^{_{q}}≤2 is obtained,

If weᵢₖ^{l}^{ᵢ}−pᵢ−Δₖ≤we_{qk}^{l}^{_{q}} and weᵢₖ^{l}^{ᵢ}−ws_{qk}^{l}^{_{q}}<η_{iq}^{k}, an inequality xᵢₖ^{l}^{ᵢ}+xⱼₖ^{l}^{ⱼ}+x_{qk}^{l}^{_{q}}≤2 is obtained;

If weᵢₖ^{l}^{ᵢ}−wsⱼₖ^{l}^{ⱼ}≥η_{ijq}^{k} and weⱼₖ^{l}^{ⱼ}−wsᵢₖ^{l}^{ᵢ}≥η_{ijq}^{k},

If wsᵢₖ^{l}+pᵢ+Δₖ≥ws_{qk}^{l}^{_{q}}, we_{qk}^{l}^{_{q}}−wsᵢₖ^{l}^{ᵢ}<η_{iq}^{k}, weᵢₖ^{l}^{ᵢ}−ws_{qk}^{l}^{_{q}}<η_{ijq}^{k} and we_{qk}^{l}^{_{q}}−wsⱼₖ^{l}^{ⱼ}<η_{jq}^{k}, an inequality xᵢₖ^{l}^{ᵢ}+xⱼₗ^{l}^{ⱼ}+x_{qk}^{l}^{_{q}}≤2 is obtained;

If we_{qk}^{l}^{_{q}}−wsᵢₖ^{l}^{ᵢ}<η_{ijq}^{k}, weⱼₖ^{l}^{ⱼ}−ws_{qk}^{l}^{_{q}}<η_{jq}^{k}, weᵢₖ^{l}^{ᵢ}−pᵢ−Δₖ≤we_{qk}^{l}^{_{q}} and weᵢₖ^{l}^{ᵢ}−ws_{qk}^{l}^{_{q}}<η_{iq}^{k}, an inequality xᵢₖ^{l}^{ᵢ}+xⱼₖ^{l}^{ⱼ}+x_{qk}^{l}^{_{q}}≤2 is obtained;

If wsᵢₖ^{l}+pᵢ+Δₖ≥ws_{qk}^{l}^{_{q}}, we_{qk}^{l}^{_{q}}−wsᵢₖ^{l}^{ᵢ}<η_{iq}^{k}, weᵢₖ^{l}^{ᵢ}−pᵢ−Δₖ≤we_{qk}^{l}^{_{q}} and weᵢₖ^{l}^{ᵢ}−ws_{qk}^{l}^{_{q}}<η_{iq}^{k}, an inequality xᵢₖ^{l}^{ᵢ}+xⱼₖ^{l}^{ⱼ}+x_{qk}^{l}^{_{q}}≤2 is obtained;

Referring to FIG. 4(j), in response to determining wsᵢₖ^{l}^{ᵢ}≤wsⱼₖ^{l}^{ⱼ}≤ws_{qk}^{l}^{_{q}}<we_{qk}^{l}^{_{q}}≤weᵢₖ^{l}^{ᵢ}<weⱼₖ^{l}^{ⱼ}, if weⱼₖ^{l}^{ⱼ}−wsᵢₖ^{l}^{ᵢ}<η_{ijq}^{k}, an inequality xᵢₖ^{l}^{ᵢ}+xⱼₖ^{l}^{ⱼ}+x_{qk}^{l}^{_{q}}≤Φ(weᵢₖ^{l}^{ᵢ}, weⱼₖ^{l}^{ⱼ}, P) is obtained.

Otherwise, if we_{qk}^{l}^{_{q}}−wsᵢₖ^{l}^{ᵢ}<η_{iq}^{k}, weᵢₖ^{l}^{ᵢ}−wsⱼₖ^{l}^{ⱼ}<η_{ijq}^{k} and weⱼₖ^{l}^{ⱼ}−ws_{qk}^{l}^{_{q}}<η_{ijq}^{k}, an inequality xᵢₖ^{l}^{ᵢ}+xⱼₖ^{l}^{ⱼ}+x_{qk}^{l}^{_{q}}≤2 is obtained;

If weᵢₖ^{l}^{ᵢ}−ws_{qk}^{l}^{_{q}}<η_{iq}^{k}, we_{qk}^{l}^{_{q}}−wsᵢₖ^{l}^{ᵢ}<η_{ijq}^{k}, wsᵢₖ^{l}^{ᵢ}+Pᵢ+Δₖ<ws_{qk}^{l}^{_{q}} and weⱼₖ^{l}^{ⱼ}−ws_{qk}^{l}^{_{q}}<η_{jq}^{k}, an inequality xᵢₖ^{l}^{ᵢ}+xⱼₖ^{l}^{ⱼ}+x_{qk}^{l}^{_{q}}≤2 is obtained;

If weᵢₖ^{l}^{ᵢ}−wsⱼₖ^{l}^{ⱼ}<η_{ijq}^{k}, we_{qk}^{l}^{_{q}}−wsᵢₖ^{l}^{ᵢ}<η_{ijq}^{k}, wsᵢₖ^{l}^{ᵢ}+Pᵢ+Δₖ<ws_{qk}^{l}^{_{q}} and weⱼₖ^{l}^{ⱼ}−ws_{qk}^{l}^{_{q}}<η_{jq}^{k}, an inequality xᵢₖ^{l}^{ᵢ}+xⱼₖ^{l}^{ⱼ}+x_{qk}^{l}^{_{q}}≤2 is obtained;

According to the obtained inequality, the non-dominant inequality can be obtained.

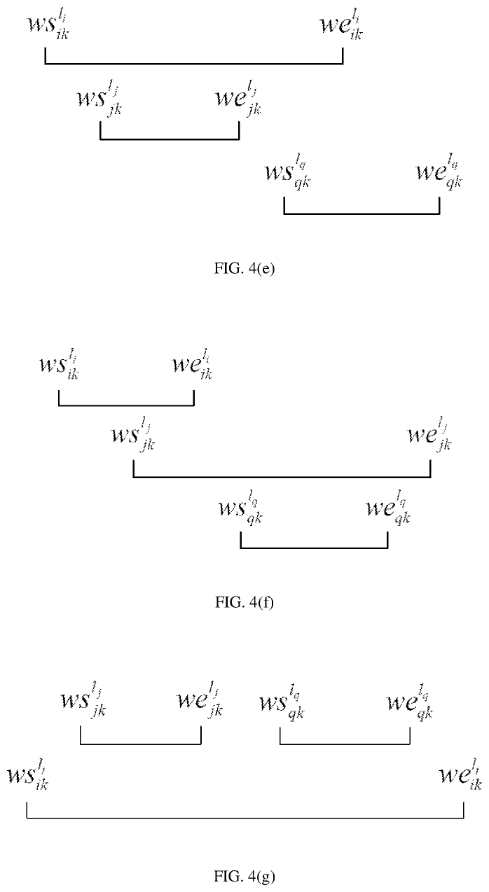

As an optional embodiment, referring to FIG. 5, the finding the non-dominant inequality according to the obtained inequality in the previous embodiment specifically includes:

S301: accessing each time node in time sequence for each implementor.

S302: recording a start time BeginTime of the time interval and a first time window of the time interval in response to determining that the current time node t is a first start time node of a certain time interval;

S303: updating a set of accessed time windows in response to determining that the current time node is the end time node of a certain time window and obtaining an effective inequality of the object to be processed in the accessed time window in a time interval [BeginTime, t];

S304: comparing the effective inequality with inequalities in the existing inequality set, and discarding the effective inequality in response to determining that the effective inequality is a dominant inequality; and adding the effective inequality to the inequality set in response to determining that the effective inequality is a non-dominant inequality;

S305: removing the dominated inequalities from the inequality set in response to determining that there are inequalities in the inequality set that are dominated or jointly dominated by the effective inequality;

S306: in response to determining that the current time node t is an end time node of the last time window of a certain time interval, deleting the time node of the first time window tw^{l}ⱼₖ, and continuing to access remaining time nodes from the first time node in sequence;

S307: adding all of the non-dominant inequalities in the inequality set to the model.

In this embodiment, an algorithm is proposed to find and recognize the effective inequality. Similar to preprocessing algorithms, an inequality recognition and search algorithm are also based on time nodes and rolling time windows. Definition of inequality domination is as follows:

Definition 1: For two effective inequalities

$${\sum }_{i ∈ I} {x}_{i} <= {b}_{i} , {\sum }_{j ∈ J} {x}_{j} <= {b}_{j} ,$$

when J⊆I, bᵢ<=bⱼ and I=J, bᵢ=bⱼ are not held at the same time, the inequality

$${\sum }_{i ∈ I} {x}_{i} <= {b}_{i}$$

dominates the inequality

$${\sum }_{j ∈ J} {x}_{j} <= {b}_{j} .$$

Note that if the inequality

$${\sum }_{i ∈ I} {x}_{i} <= {b}_{i}$$

dominates

$${\sum }_{j ∈ J} {x}_{j} <= {b}_{j} ,$$

then

$$\{ x ∈ {B}^{n} : {\sum }_{i ∈ I} {x}_{i} <= {b}_{i} \} ⊆ \{ x ∈ {B}^{n} : {\sum }_{j ∈ J} {x}_{j} <= {b}_{j} \} .$$

Definition 2: for an inequality e:

$${\sum }_{j ∈ J} {x}_{j} <= {b}_{j} ,$$

it is jointly dominated by k inequalities (k>=2):

$${\sum }_{i ∈ {I}_{q}} {x}_{i} <= {b}_{q} , q = 1 , … , k ,$$

when

$$J ⊆ {⋃}_{q = 1 , … , k} {I}_{q} {\sum }_{q = 1 , … , k} {b}_{q} <= {b}_{j} .$$

Definition 3: If an inequality e is neither dominated by another inequality nor jointly by other k (k≥2) inequalities, then the inequality e is a non-dominated inequality; otherwise, the inequality e is a dominant inequality.

In this embodiment, in order to avoid excessive constraints and a large model, only non-dominant inequalities are added.

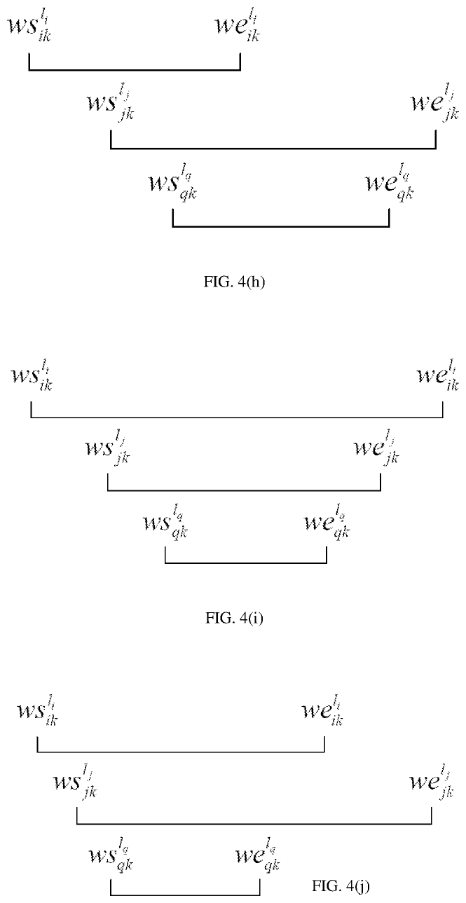

As a specific example, referring to FIG. 6, there are 5 objects to be processed, and each object to be processed is associated with one processing time window. The five overlapping time windows form a feasible time interval. In addition, the processing time of the five objects to be processed is 6, 6, 8, 5 and 4, respectively. For convenience of description, the switching time between every two objects to be processed is set to be 0. This assumption will not affect an algorithm workflow.

A process of adding inequality is described in detail in Table 4. The inequality x1+x2+x4≤2 is jointly dominated by the existing inequality x1+x2≤1 and the implicit inequality x4≤1, so x1+x2+x4≤2 is discarded (round 0, time 14). The resulting inequality x2+x3+x4≤2 is dominated by the existing inequality x1+x2+x3+x4≤2 (round 1, time 16). Further, the inequality x1+x2+x3+x4≤2 in the inequality set is jointly dominated by the newly obtained inequality x3+x4≤1 and the existing inequality x1+x2≤1 (round 2, time 16). Therefore, the inequality x1+x2+x3+x4≤2 is removed from the inequality set. Finally, only the non-dominant inequalities x1+x2≤1 and x3+x4≤1 are added to the model.

TABLE 4
Inequality recognition and addition process.

| round | time t | TWS | inequality e | set Inequalities |
|---|---|---|---|---|
| 0 | 0 | ∅ | / | ∅ |
| | 2 | ∅ | / | ∅ |
| | 4 | ∅ | / | ∅ |
| | 6 | ∅ | / | ∅ |
| | 8 | x₁ | / | ∅ |
| | 10 | x₁, x₂ | x₁ + x₂ ≤ 1 | ∅ |
| | 14 | x₁, x₂, x₃ | x₁ + x₂ + x₄ ≤ 2 | x₁ + x₂ ≤ 1 |
| | 16 | x₁, x₂, x₃, x₄ | x₁ + x₂ + x₃ + x₄ ≤ 2 | x₁ + x₂ ≤ 1 |
| | 18 | x₁, x₂, x₃, x₄, x₅ | x₁ + x₂ + x₃ + x₄ + x₅ ≤ 3 | x₁ + x₂ ≤ 1, x₁ + x₂ + x₃ + x₄ ≤ 2 |
| 1 | 2 | ∅ | / | x₁ + x₂ ≤ 1, x₁ + x₂ + x₃ + x₄ ≤ 2 |
| | 4 | ∅ | / | x₁ + x₂ ≤ 1, x₁ + x₂ + x₃ + x₄ ≤ 2 |
| | 6 | ∅ | / | x₁ + x₂ ≤ 1, x₁ + x₂ + x₃ + x₄ ≤ 2 |
| | 10 | x₂ | / | x₁ + x₂ ≤ 1, x₁ + x₂ + x₃ + x₄ ≤ 2 |
| | 14 | x₂, x₄ | / | x₁ + x₂ ≤ 1, x₁ + x₂ + x₃ + x₄ ≤ 2 |
| | 16 | x₂, x₃, x₄ | x₂ + x₃ + x₄ ≤ 2 | x₁ + x₂ ≤ 1, x₁ + x₂ + x₃ + x₄ ≤ 2 |
| | 18 | x₂, x₃, x₄, x₅ | x₂ + x₃ + x₄ + x₅ ≤ 3 | x₁ + x₂ ≤ 1, x₁ + x₂ + x₃ + x₄ ≤ 2 |
| 2 | 4 | ∅ | / | x₁ + x₂ ≤ 1, x₁ + x₂ + x₃ + x₄ ≤ 2 |
| | 6 | ∅ | / | x₁ + x₂ ≤ 1, x₁ + x₂ + x₃ + x₄ ≤ 2 |
| | 14 | x₄ | / | x₁ + x₂ ≤ 1, x₁ + x₂ + x₃ + x₄ ≤ 2 |
| | 16 | x₃, x₄ | x₃ + x₄ ≤ 1 | x₁ + x₂ ≤ 1, x₁ + x₂ + x₃ + x₄ ≤ 2 |
| | 18 | x₃, x₄, x₅ | x₃ + x₄ + x₅ ≤ 2 | x₁ + x₂ ≤ 1, x₃ + x₄ ≤ 1 |
| 3 | 6 | ∅ | / | x₁ + x₂ ≤ 1, x₃ + x₄ ≤ 1 |
| | 14 | x₄ | / | x₁ + x₂ ≤ 1, x₃ + x₄ ≤ 1 |
| | 16 | x₃, x₄ | x₃ + x₄ ≤ 1 | x₁ + x₂ ≤ 1, x₃ + x₄ ≤ 1 |
| 4 | 6 | ∅ | / | x₁ + x₂ ≤ 1, x₃ + x₄ ≤ 1 |
| | 16 | x₃ | / | x₁ + x₂ ≤ 1, x₃ + x₄ ≤ 1 |

In this embodiment, by adding non-dominant inequalities, the model can be solved more easily.

In contrast, referring to Table 5, the number of the inequalities in the model in this embodiment is larger than that in Chen et al. In addition, the number of inequalities in the model is much smaller than that in the model containing all inequalities, because the dominant inequalities are ignored. According to theoretical analysis results, the number of the inequalities in the model should be almost ½ of the number of the inequalities in an original mode (n²/4 vs n(n−1)/2) However, in fact, the number of the inequalities in the model is much smaller (less than ¼ of that of the original model). As for the model in this embodiment, the combination of the model in this embodiment and Chen's model, and Chen's model, the model the inequalities of which is included in this embodiment is the best in most instances, with a shorter optimal solution distance and shorter solution time. This is because more inequalities make the model tighter and easier to be solved.

TABLE 5
Performance evaluation for different reinforcement strategies.

| | Uppe [symbol] | Chen [symbol] strengthening [7] | | | Model w [symbol] th all the [symbol] | | | Model with ta [symbol] | | |
|---|---|---|---|---|---|---|---|---|---|---|
| Inst [symbol] ce | bound | Gap | Time(s) | Num | Gap | Time(s) | Num | Gap | Time(s) | N [symbol] m |
| 5-5-100 | [symbol] 70 | 0 | 0.0 [symbol] | 0 | 0 | 0.0 [symbol] | 0 | 0 | 0.0 [symbol] | 0 |
| 5-5-200 | 1012 | 0 | 0.05 | 0 | 0 | 0.05 | 0 | 0 | 0.07 | 0 |
| 5-10-200 | 1081 | 0 | 0.0 [symbol] | 0 | 0 | 0.08 | 0 | 0 | 0.0 [symbol] | 0 |
| 5-10-400 | 1 [symbol] 68 | 0 | 30.21 | 56 | 0 | 14.70 | 1002 | 0 | 11.12 | 275 |
| 5-15-200 | 1129 | 0 | 18.74 | [symbol] 0 | 0 | 14.99 | 3617 | 0 | 18.47 | [symbol] 21 |
| 5-15-400 | 21 [symbol] | 0 | [symbol] | [symbol] 0 | 0 | 205.47 | [symbol] 70 | 0 | 24 [symbol] .82 | 11 [symbol] 7 |
| 5-20-200 | 112 [symbol] | 0 | 6 [symbol] .94 | [symbol] 0 | 0 | 38.17 | [symbol] | 0 | 79.62 | 1956 |
| 5-20- [symbol] 00 | 216 [symbol] | 0 | — | 60 | 0 | 1075.58 | 10718 | 0. [symbol] | — | 20 [symbol] |
| 5-20-600 | 31 [symbol] | 0.96 | — | 60 | 0.67 | — | 11351 | 0.96 | — | 2137 |
| 10-5-200 | 1103 | 0 | 0.08 | 0 | 0 | 0.05 | 0 | 0 | 0.0 [symbol] | 0 |
| 10-5-400 | 2041 | 0 | 0.11 | 0 | 0 | 0.1 [symbol] | 0 | 0 | 0.13 | 0 |
| 10-10- [symbol] 00 | 1129 | 0 | 0.0 [symbol] | 0 | 0 | 0.08 | 0 | 0 | 0.14 | 0 |
| 10-10-400 | 2237 | 0 | 0.27 | 0 | 0 | 0.2 [symbol] | 0 | 0 | 0.28 | 0 |
| 10-10-600 | 3045 | 0 | 0.02 | 0 | 0 | 0.7 [symbol] | 1 | 0 | 0.83 | 1 |
| 10-15-400 | 2241 | 0 | 126. [symbol] 8 | 120 | 0 | 81.76 | 5992 | 0 | 59.32 | 21 [symbol] 0 |
| 10-15- [symbol] 00 | 3205 | 0 | 24 [symbol] .7 [symbol] | 120 | 0 | 1 [symbol] .2 [symbol] | 1 [symbol] 26 | 0 | 1 [symbol] 4.41 | 22 [symbol] |
| 10-15-800 | 4099 | 0.04 | 1202.40 | 121 | 0 | 727.47 | 1123 [symbol] | 0 | — | 2 [symbol] |
| 10-20- [symbol] 00 | 2173 | 0 | 2 [symbol] .07 | 121 | 0 | 101.01 | 10218 | 0 | 115.71 | 3795 |
| 10-20-600 | 323 [symbol] | 0 | [symbol] 6. [symbol] 4 | 120 | 0 | 470. [symbol] | 2 [symbol] 20 [symbol] | 0 | 5 [symbol] 4.07 | 3045 |
| 10-20-800 | 4 [symbol] 20 | 0.03 | — | 120 | 0.05 | — | 23 [symbol] 9 | 0.02 | — | 4 [symbol] 4 |
| 10-20-1000 | 5302 | 0.06 | — | 120 | 0.97 | — | 23262 | 0.97 | — | 4245 |
| 15-5-200 | 1111 | 0 | 0.0 [symbol] | 0 | 0 | 0.0 [symbol] | 0 | 0 | 0.08 | 0 |
| 15-5- [symbol] 00 | 2172 | 0 | 0.13 | 0 | 0 | 0.11 | 0 | 0 | 0.19 | 0 |
| 15-5-600 | 3024 | 0 | 0.27 | 0 | 0 | 0.27 | 0 | 0 | 0.25 | 0 |
| 15-10-400 | 2218 | 0 | 0.27 | 0 | 0 | 0.30 | 0 | 0 | 0.41 | 0 |
| 15-10-600 | 3290 | 0 | 0.66 | 1 | 0 | 0.62 | 1 | 0 | 0.75 | 1 |
| 15-10-800 | 4211 | 0 | 1.12 | 0 | 0 | 1.48 | 0 | 0 | 1.28 | 0 |
| 15-10-400 | 22 [symbol] 3 | 0 | 1.31 | 0 | 0 | 1. [symbol] | 0 | 0 | 1.25 | 0 |
| 15-15-600 | 33 [symbol] | 0 | 1 [symbol] .26 | 181 | 0 | 97.1 [symbol] | 14770 | 0 | [symbol] 8 [symbol] .18 | 3237 |
| 15-15-800 | 4328 | 0 | 360.08 | 180 | 0 | 7 [symbol] 4.76 | 1 [symbol] 788 | 0 | 271.09 | 3593 |
| 15-15-1000 | 53 [symbol] 1 | 0 | 989.84 | 180 | 0 | 492.49 | 17378 | 0 | 1200 | 3715 |
| 15-20-600 | 3235 | 0 | 745. [symbol] | 180 | 0 | 294.12 | 32083 | 0 | 63 [symbol] .06 | 6013 |
| 15-20-800 | 4338 | 0. [symbol] | — | 180 | 0 | 1022.04 | 31 [symbol] 87 | 0 | — | [symbol] |
| 15-20-1000 | [symbol] 431 | 0. [symbol] | — | 181 | 0. [symbol] 6 | — | [symbol] 120 | 0.9 [symbol] | — | 63 [symbol] 1 |
| 20-5-400 | 2207 | 0 | 0.1 [symbol] | 0 | 0 | 0.14 | 0 | 0 | 0.19 | 0 |
| 20-5-600 | 3149 | 0 | 0.22 | 0 | 0 | 0.19 | 0 | 0 | 0.3 [symbol] | 0 |
| 20-5- [symbol] 00 | 3 [symbol] 51 | 0 | 0.44 | 0 | 0 | 0.33 | 0 | 0 | 0.44 | 0 |
| 20-10-400 | 220 [symbol] | 0 | 0.28 | 0 | 0 | 0.27 | 0 | 0 | 0.34 | 0 |
| 20-10-600 | 31 [symbol] 5 | 0 | 0.56 | 0 | 0 | 0.55 | 0 | 0 | 0. [symbol] 8 | 0 |
| 20-10-800 | [symbol] 15 | 0 | 1. [symbol] 7 | 0 | 0 | 1.59 | 0 | 0 | 1.50 | 0 |
| 20-10-1000 | 5303 | 0 | 3.42 | 1 | 0 | 3.4 [symbol] | 2 | 0 | 3.?? | 2 |
| 20-15-600 | 3301 | 0 | [symbol] .70 | 0 | 0 | [symbol] . [symbol] | 0 | 0 | 3.50 | 0 |
| 20-15-800 | 4321 | 0 | 202.5 [symbol] | 241 | 0 | 232. [symbol] 0 | 152 [symbol] 0 | 0 | 17 [symbol] .58 | 34 [symbol] |
| 20-15-1000 | 53 [symbol] 5 | 0 | 898.60 | 243 | 0 | 877.01 | 21123 | 0 | 644.16 | 4 [symbol] 66 |
| 20-20-800 | 4 [symbol] 98 | 0 | 835.98 | 240 | 0 | 713.03 | [symbol] | 0 | — | 7580 |
| 20-20-1000 | 5065 | 0.92 | — | 240 | 0.92 | — | 42 [symbol] | 0.92 | — | 8023 |
| 20-20-1200 | 0707 | 0.95 | — | 240 | 0.95 | — | 45730 | 0.95 | — | [symbol] |

[symbol]

indicates data missing or illegible when filed

It should be noted that the method of the embodiment of the present disclosure can be performed by a single device, such as a computer or a server. The method of this embodiment can also be applied to distributed scenarios, which is completed by cooperation of multiple devices. In this distributed scenario, one of the devices can only perform one or more of the steps in the method of the embodiment of the disclosure, and the devices can interact with each other to complete the method.

It should be noted that some embodiments of the present disclosure have been described above. Other embodiments are within the scope of the appended claims. In some cases, actions or steps recited in the claims may be performed in a different order from that in the above embodiments and still achieve the desired results. In addition, the processes depicted in the drawings do not necessarily require the specific or sequential order shown to achieve the desired results. In some embodiments, multitasking and parallel processing are also possible or may be advantageous.

On a basis of the same concept, corresponding to the method of any of the above embodiments, a scheduling device for an unrelated parallel machine is also provide in this disclosure.

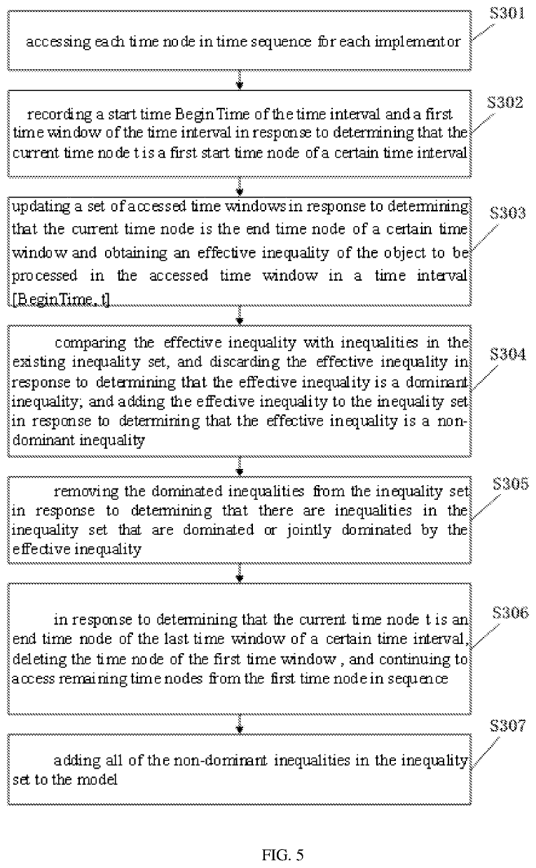

Referring to FIG. 7, the scheduling device for the unrelated parallel machine includes:

a first processing module configured to process an object to be processed within a corresponding time window in response to determining that a first variable is 1, and take a second variable to be 0 in response to determining that the first variable is 0; and schedule the object to be processed according to the first variable and the second variable, wherein the first variable indicates whether the object to be processed is scheduled to a time window corresponding to an implementer, if the object to be processed is scheduled to the time window corresponding to the implementer, the first variable is 1, otherwise, the first variable is 0; and the second variable indicates a start time when the object to be processed are allocated to the time window, and each object to be processed is processed at most once;

a second processing module configured to process the second object to be processed before the first object to be processed in response to determining that a latest end time of the first object to be processed is less than a sum of an earliest start time of the second object to be processed and switching time of the implementer; and process the second object to be processed after the first object to be processed in response to determining that the latest end time of the first object to be processed is greater than the sum of the earliest start time of the second object to be processed and the switching time of the implementer;

a third processing module configured to process the first object to be processed before the second object to be processed in response to determining that the third variable is 1; and process the first object to be processed after the second object to be processed in response to determining that the fourth variable is 1; wherein the third variable and the fourth variable respectively indicate scheduling orders of the first object to be processed and the second object to be processed, and the third variable and the fourth variable satisfy switching time constraint, consistency constraint and the domain constraint; and

a scheduling module configured to establish a mixed integer linear programming model according to above conditions, solving it to obtain a scheduling scheme for scheduling the object to be processed with a maximum total revenue, and schedule the object according to the scheduling scheme.

For convenience of description, when the above devices are described, it is made for various modules in terms of functions. Of course, when this disclosure is implemented, the functions of each module can be implemented in one or more pieces of software and/or hardware.

The device in the above embodiments is used to implement the corresponding scheduling method for the unrelated parallel machine in any of the above embodiments, and present beneficial effects of the corresponding method embodiments, which will not be described in detail here.

On a basis of the same concept, corresponding to the method of any of the above embodiments, an electronic device is also provided in this disclosure, which includes a memory, a processor and a computer program stored on the memory and operable on the processor, and the processor implements the scheduling method for the unrelated parallel machine described in any one of the above embodiments when executing the program.

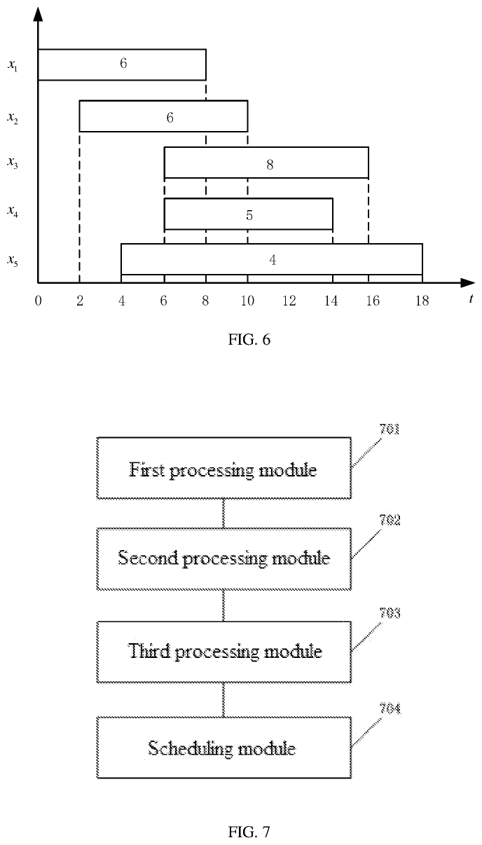

FIG. 8 shows a more specific hardware structure diagram of an electronic device provided in this embodiment, which may include a processor 1010, a memory 1020, an input/output interface 1030, a communication interface 1040 and a bus 1050. A communication connection with each other is realized among the processor 1010, the memory 1020, the input/output interface 1030 and the communication interface 1040 in the device through the bus 1050.

The processor 1010 can be implemented by a general-purpose CPU (Central Processing Unit), a microprocessor, an application specific integrated circuit (ASIC), or one or more integrated circuits, etc., and is used for executing relevant programs to realize technical schemes provided in the embodiments of this specification.

The memory 1020 can be implemented in a form of ROM (Read Only Memory), RAM (Random Access Memory), static storage device, dynamic storage device, or the like. The memory 1020 can store the operating system and other application programs. When the technical schemes provided in the embodiments of this specification is implemented by software or firmware, relevant program codes are stored in the memory 1020 and called and executed by the processor 1010.

The input/output interface 1030 is used to connect the input/output module to realize information input and output. The input/output module can be configured as a component in the device (not shown in the figure), or it can be externally connected to the device to provide corresponding functions. An input device can include a keyboard, a mouse, a touch screen, a microphone and various sensors, and an output device can include a display, a speaker, a vibrator and an indicator.

The communication interface 1040 is used to connect with a communication module (not shown in the figure) to realize communication interaction between the device and other devices. The communication module can communicate by wired means (such as USB, network cable, etc.) or by wireless means (such as mobile network, WIFI, Bluetooth, etc.).

The bus 1050 includes a path for transmitting information among various components of the device, such as the processor 1010, the memory 1020, the input/output interface 1030 and the communication interface 1040.

It should be noted that although the above device only shows the processor 1010, the memory 1020, the input/output interface 1030, the communication interface 1040 and the bus 1050, in the specific implementation process, the device may also include other components necessary for normal operation. In addition, it can be understood by those skilled in the art that the above-mentioned device may only contain the components necessary for implementing the embodiments of this specification, and need not contain all the components shown in the drawings.

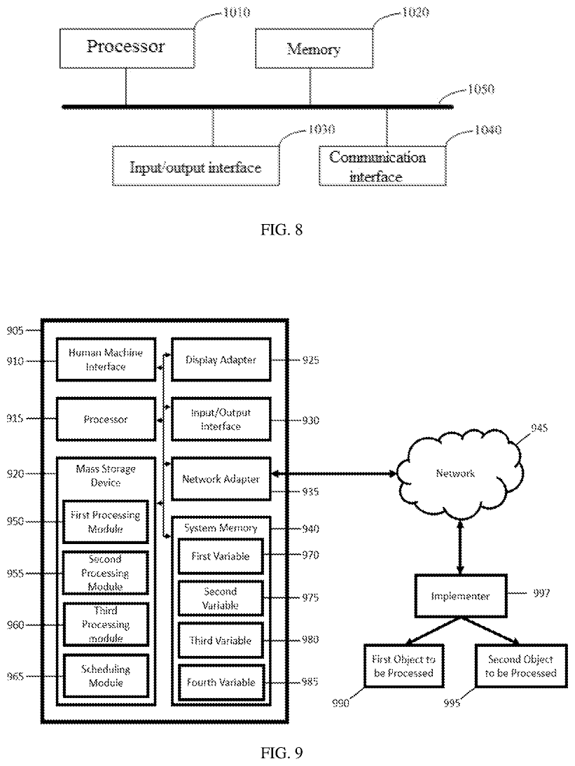

Referring to FIG. 9, the methods and systems of the present disclosure may be implemented on one or more computers, such as computer 905. The methods and systems disclosed may utilize one or more computers to perform one or more functions in one or more locations. The processing of the disclosed methods and systems may also be performed by software components. The disclosed systems and methods may be described in the general context of computer-executable instructions such as program modules, being executed by one or more computers or devices. For example, the program modules include operating modules such as First Processing Module 950, Second Processing Module 955, Third Processing Module 960, Scheduling Module 965, and the like.

First Processing Module 950 may be configured to process first object to be processed 990 within a corresponding time window in response to determining that first variable 970 is 1, and take second variable 975 to be 0 in response to determining that first variable 970 is 0; and schedule first object to be processed 990 according to first variable 970 and second variable 975, wherein first variable 970 indicates whether first object to be processed 990 is scheduled to a time window corresponding to implementer 997, if first object to be processed 990 is scheduled to the time window corresponding to implementer 997, first variable 970 is 1, otherwise, first variable 970 is 0; and second variable 975 indicates a start time when first object to be processed 990 is allocated to the time window, and each object to be processed (e.g., first object to be processed 990 and second object to be processed 995) is processed at most once.

Second Processing Module 955 may be configured to process second object to be processed 995 before first object to be processed 990 in response to determining that a latest end time of first object to be processed 990 is less than a sum of an earliest start time of second object to be processed 995 and switching time of implementer 997; and process second object to be processed 995 after first object to be processed 990 in response to determining that the latest end time of first object to be processed 990 is greater than the sum of the earliest start time of second object to be processed 995 and the switching time of implementer 997.

Third Processing Module 960 may be configured to process first object to be processed 990 before second object to be processed 995 in response to determining that third variable 980 is 1; and process first object to be processed 990 after second object to be processed 995 in response to determining that fourth variable 985 is 1; wherein third variable 980 and fourth variable 985 respectively indicate scheduling orders of first object to be processed 990 and second object to be processed 995, and third variable 980 and fourth variable 985 satisfy the switching time constraint, consistency constraint and the domain constraint.

Scheduling Module 965 may be configured to establish a mixed integer linear programming model according to above conditions, solving the mixed linear programming model to obtain a scheduling scheme for scheduling first object to be processed 990 with a maximum total revenue, and schedule the object according to the scheduling scheme.

These program modules may be stored on mass storage device 920 of one or more computers devices, and may be executed by one or more processors, such as processor 915. Each of the operating modules may comprise elements of programming and data management software.

The variables of the present embodiment (e.g. first variable 970, second variable 975, third variable 980, and fourth variable 985) may be used separately or in combination in the system and method of the present disclosure. The variables may be stored, for example, without limitation, on system memory 940.

The components of the one or more computers may comprise, but are not limited to, one or more processors or processing units, such as processor 915, system memory 940, mass storage device 920, Input/Output Interface 930, display adapter 925, network adaptor 935, and a system bus that couples various system components. The one or more computers and implementer 997 may be implemented over a wired or wireless network connection at physically separate locations, implementing a fully distributed system. Additionally, implementer 997 may include the one or more computers such that implementer 997 and the one or more computers may be implemented in a same physical location. By way of example, without limitation, the one or more computers may be a personal computer, a portable computer, a smart device, a network computer, a peer device, or other common network node, and so on. Logical connections between one or more computers and implementer 997 may be made via network 945, such as a local area network (LAN) and/or a general wide area network (WAN).

Implementer 997 may be, for example, without limitation, a satellite configured to process first object to be processed 990, second object to be processed 995, etc. First object to be processed 990, second object to be processed 995, etc. may be objects to be observed via implementer 997. For example, without limitation, the objects to be processed may be geographical locations, vehicles, buildings, etc. Additionally, the objects to be processed may not be on the surface of the Earth, and may be, for example, without limitation, satellites, spacecraft, asteroids, etc. Additionally, implementer 997 and objects to be processed may be different depending on the environment. For example, without limitation, in a scenario of machining mechanical parts, the object to be processed may be a part to be machined, and the implementer may be a lathe. In a vehicle routing problem, the object to be processed can be a path of the vehicle, and the implementer can be the vehicle itself; and in a scenario of satellite scheduling, the object to be processed can be a task of the satellite, and the implementer can be the satellite itself.

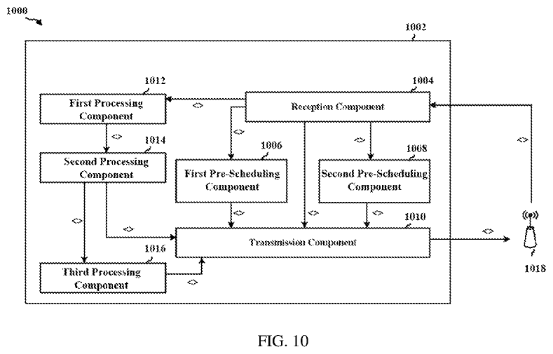

FIG. 10 is a conceptual data flow diagram 1000 illustrating the data flow between different means/components in an exemplary apparatus 1002. The apparatus includes a reception component 1004 configured to acquire time node information of each implementer and access the time nodes on the implementer in sequence according to the time node information, update an end time of the accessed time window in response to determining that the number of the accessed time window is less than are equal to 3, with the updated end time not exceeding a current time node, and scheduling remaining objects to be processed, a first processing component 1012 configured to process a first object to be processed within a corresponding time window in response to determining that a first variable is 1, and take a second variable to be 0 in response to determining that the first variable is 0; and schedule the first object to be processed according to the first variable and the second variable, wherein the first variable indicates whether the first object to be processed is scheduled to a time window corresponding to an implementer, if the first object to be processed is scheduled to the time window corresponding to the implementer, the first variable is 1, otherwise, the first variable is 0; and the second variable indicates a start time when the first object to be processed is allocated to the time window, and each object to be processed is processed at most once, a second processing component 1014 configured to process a second object to be processed before the first object to be processed in response to determining that a latest end time of the first object to be processed is less than a sum of an earliest start time of the second object to be processed and a switching time of the implementer; and process the second object to be processed after the first object to be processed in response to determining that the latest end time of the first object to be processed is greater than the sum of the earliest start time of the second object to be processed and the switching time of the implementer, and a third processing component configured to process the first object to be processed before the second object to be processed in response to determining that a third variable is 1; and process the first object to be processed after the second object to be processed in response to determining that a fourth variable is 1; wherein the third variable and the fourth variable respectively indicate scheduling orders of the first object to be processed and the second object to be processed, and the third variable and the fourth variable satisfy a switching time constraint, a consistency constraint and a domain constraint. Apparatus 1002 may also include a first pre-scheduling component 1006 configured to pre-schedule the object to be processed in the accessed time window in response to determining that the object to be processed in the accessed time window can be successfully scheduled, and delete time windows of the objects to be processed on all implementers in the accessed time windows, and a second pre-scheduling component 1008 configured to pre-schedule the object to be processed before the end time of the time window in time sequence in response to determining that the number of the accessed time windows is greater than 3, update start time of time windows of the remaining objects to be processed in the accessed time windows after successfully pre-scheduling one object to be processed each time, and schedule the remaining objects to be processed until a number of time windows of remaining unscheduled objects to be processed is less than or equal to 3. Transmission component 1010 is configured to transmit the results of apparatus 1002 to receiver 1018.

The apparatus may include additional components that perform each of the blocks of the algorithm in the aforementioned flowcharts of FIGS. 1-2. As such, each block in the aforementioned flowcharts of FIGS. 1-2 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

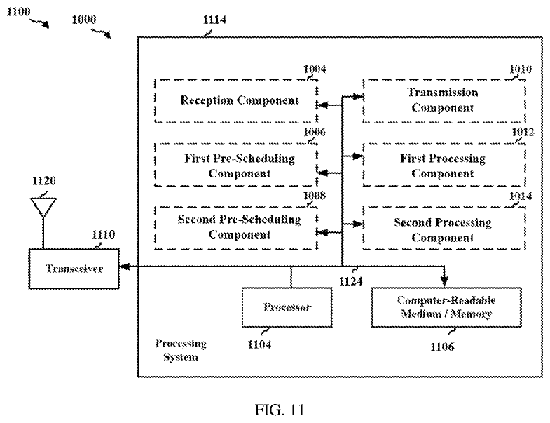

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1012, 1014, and 1016, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1010, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1012, 1014, and 1016. The components may be software components running in the processor 1104, resident/stored in the computer readable medium/memory 1106, one or more hardware components coupled to the processor 1104, or some combination thereof.

In one configuration, the apparatus 1002 includes means for acquiring time node information of each implementer, means for accessing the time nodes on the implementer in sequence according to the time node information, updating an end time of an accessed time window in response to determining that the number of the accessed time windows is less than or equal to 3, with the updated end time not exceeding a current time node, and scheduling remaining objects to be processed, means for pre-scheduling the object to be processed in the accessed time window in response to determining that the object to be processed in the accessed time window can be successfully scheduled, and deleting time windows of the objects to be processed on all implementers in the accessed time windows, and means for pre-scheduling the object to be processed before the end time of the time window in time sequence in response to determining that the number of the accessed time windows is greater than 3, updating start time of time windows of the remaining objects to be processed in the accessed time windows after successfully pre-scheduling one object to be processed each time, and scheduling the remaining objects to be processed until a number of time windows of remaining unscheduled objects to be processed is less than or equal to 3. Additionally, apparatus 1002 includes means for processing a first object to be processed, via an implementer, within a corresponding time window in response to determining that a first variable is 1, and taking a second variable to be 0 in response to determining that the first variable is 0; and scheduling the first object to be processed according to the first variable and the second variable, wherein the first variable indicates whether the first object to be processed is scheduled to a time window corresponding to the implementer, if the first object to be processed is scheduled to the time window corresponding to the implementer, the first variable is 1, otherwise, the first variable is 0; and the second variable indicates a start time when the first object to be processed are allocated to the time window, and each object to be processed is processed at most once, means for processing a second object to be processed, via the implementer, before the first object to be processed in response to determining that a latest end time of the first object to be processed is less than a sum of an earliest start time of the second object to be processed and a switching time of the implementer; and processing the second object to be processed after the first object to be processed in response to determining that the latest end time of the first object to be processed is greater than the sum of the earliest start time of the second object to be processed and the switching time of the implementer, means for processing the first object to be processed before the second object to be processed, via the implementer, in response to determining that a third variable is 1; and processing the first object to be processed after the second object to be processed in response to determining that a fourth variable is 1; wherein the third variable and the fourth variable respectively indicate scheduling orders of the first object to be processed and the second object to be processed, and the third variable and the fourth variable satisfy a switching time constraint, a consistency constraint and a domain constraint, and means for establishing a mixed integer linear programming model according to above conditions via the implementer, solving the mixed integer linear programming model to obtain a scheduling scheme for scheduling an object to be processed with a maximum total revenue, and scheduling each object to be processed according to the scheduling scheme, thus obtaining an improved upper bound for a linear relaxation of the mixed integer linear programming model. The aforementioned means may be one or more of the aforementioned components of the apparatus 1002 and/or the processing system 1114 of the apparatus 1002 configured to perform the functions recited by the aforementioned means.

The electronic devices in the above embodiments are used to implement the corresponding scheduling method for the unrelated parallel machine in any of the above embodiments, and present beneficial effects of the corresponding method embodiments, which will not be described in detail here.

It should be understood by those of ordinary skill in the art that discussion of any of the above embodiments is only exemplary, and is not intended to imply that the scope of the disclosure (including the claims) is limited to these examples; under the idea of this disclosure, the technical features in the above embodiments or different embodiments can also be combined, and the steps can be realized in any order; and there are many other changes in different aspects of the embodiments of this disclosure as described above, which are not provided in details for brevity.

In addition, in order to simplify the description and discussion, and in order not to make the embodiments of the present disclosure difficult to understand, well-known power/ground connections with integrated circuit (IC) chips and other components may or may not be shown in the provided drawings. In addition, the devices can be shown in the form of block diagrams in order to avoid making the embodiments of the present disclosure difficult to understand, and this also takes into account the fact that the details about the implementation of these devices in block diagram are highly dependent on a platform on which the embodiments of the present disclosure will be implemented (i.e., these details should be completely within an understanding range of those skilled in the art). While specific details (e.g., circuits) have been set forth to describe exemplary embodiments of the present disclosure, it will be apparent to those skilled in the art that the embodiments of the present disclosure may be practiced without these specific details or with variations in these specific details. Therefore, these descriptions should be regarded as illustrative rather than restrictive.

Although the present disclosure has been described in conjunction with specific embodiments thereof, many alternatives, modifications and variations of these embodiments will be apparent to those of ordinary skill in the art based on the foregoing description.

The embodiments of the present disclosure are intended to cover all such alternatives, modifications and variations that fall within the broad scope of the append claims. Therefore, any omissions, modifications, equivalent substitutions, improvements, etc. made within the spirit and principles of the embodiments of this disclosure shall be encompassed within the protection scope of this disclosure.

1. A scheduling method for an unrelated parallel machine, comprising:
processing a first object to be processed, via an implementer, within a corresponding time window in response to determining that a first variable is 1, and taking a second variable to be 0 in response to determining that the first variable is 0; and scheduling the first object to be processed according to the first variable and the second variable, wherein the first variable indicates whether the first object to be processed is scheduled to a time window corresponding to the implementer, if the first object to be processed is scheduled to the time window corresponding to the implementer, the first variable is 1, otherwise, the first variable is 0; and the second variable indicates a start time when the first object to be processed are allocated to the time window, and each object to be processed is processed at most once;
processing a second object to be processed, via the implementer, before the first object to be processed in response to determining that a latest end time of the first object to be processed is less than a sum of an earliest start time of the second object to be processed and a switching time of the implementer; and processing the second object to be processed after the first object to be processed in response to determining that the latest end time of the first object to be processed is greater than the sum of the earliest start time of the second object to be processed and the switching time of the implementer;
processing the first object to be processed before the second object to be processed, via the implementer, in response to determining that a third variable is 1; and processing the first object to be processed after the second object to be processed in response to determining that a fourth variable is 1; wherein the third variable and the fourth variable respectively indicate scheduling orders of the first object to be processed and the second object to be processed, and the third variable and the fourth variable satisfy a switching time constraint, a consistency constraint and a domain constraint; and
establishing a mixed integer linear programming model according to above conditions via the implementer, solving the mixed integer linear programming model to obtain a scheduling scheme for scheduling an object to be processed with a maximum total revenue, and scheduling each object to be processed according to the scheduling scheme, thus obtaining an improved upper bound for a linear relaxation of the mixed integer linear programming model; thereby improving efficiency in scheduling at least the first object to be processed and the second object to be processed via the implementer; and
operating the implementer to perform switching operations according to the scheduling scheme; wherein:
the implementer comprises at least one satellite in at least one orbit;
the first object to be processed comprises a first observation target of the at least one satellite and the second object to be processed comprises a second observation target of the at least one satellite;
the switching operations are performed between continuously observing the first observation target and the second observation target;
the switching operations comprise sensor shutdown, yawing, attitude stabilization and restarting; and
visibility is determined by the at least one orbit of the at least one satellite and a target position, and thus time windows of observation are calculated based on the first observation target, the second observation target, and the at least one satellite;
thus the first observation target and the second observation target are pre-scheduled, thereby reducing a scale of problem solving with addition of effective inequalities, and a tighter upper bound of linear relaxation of the mixed integer linear programming model facilitates problem solving.

2. The scheduling method of the unrelated parallel machine according to claim 1, wherein the method further comprises preprocessing the time window before solving the mixed integer linear programming model, and the preprocessing comprises:
acquiring time node information of each implementer;
accessing the time nodes on the implementer in sequence according to the time node information, updating an end time of an accessed time window in response to determining that the number of the accessed time windows is less than or equal to 3, with the updated end time not exceeding a current time node, and scheduling remaining objects to be processed;
pre-scheduling the first object to be processed in the accessed time window in response to determining that the first object to be processed in the accessed time window can be successfully scheduled, and deleting time windows of the objects to be processed on all implementers in the accessed time windows; and
pre-scheduling the first object to be processed before the end time of the time window in time sequence in response to determining that the number of the accessed time windows is greater than 3, updating a start time of time windows of the remaining objects to be processed in the accessed time windows after successfully pre-scheduling one object to be processed each time, and scheduling the remaining objects to be processed until a number of time windows of remaining unscheduled objects to be processed is less than or equal to 3.

3. The scheduling method of the unrelated parallel machine according to claim 1, wherein the mixed integer linear programming model is expressed as:
$$max {\sum }_{j ∈ J} {\sum }_{k ∈ M} {\sum }_{l ∈ {TW}_{ik}} {w}_{i} \cdot {x}_{ik}^{l}$$
wherein the model includes two virtual objects to be processed, namely {0, n+1}, which correspond to a starting and ending objects to be processed, J represents a set of the objects to be processed, M represents a set of the implementers, i, j∈J∪{0, n+1}, k∈M, l∈TWⱼₖ and for each object j to be processed, j∈J, the profit is wⱼ, xⱼₖ^{l} represents the first variable; if the object j to be processed is scheduled to a l-th time window on an implementer k, xⱼₖ^{l}=1, otherwise, xⱼₖ^{l}=0; there are multiple time windows for each object to be processed j and each implementer k, which are defined as TWⱼₖ={twⱼₖ¹, twⱼₖ², . . . , twⱼₖ^{|TW}ⱼₖ|}, |TWⱼₖ| represents a number of time windows of the object j to be processed on the implementer k, twⱼₖ^{l}=[wsⱼₖ^{l}, weⱼₖ^{l}] represents the l-th time window of the object j to be processed on the implementer k, and wsⱼₖ^{l}, wsⱼₖ^{l} respectively represents time nodes at both ends of the l-th time window of the object j to be processed on the implementer k.

4. The scheduling method of the unrelated parallel machine according to claim 3, wherein the processing the first object to be processed within a corresponding time window in response to determining that the first variable is 1 and taking the second variable to be 0 in response to determining that the first variable is 0 indicates time window constraint, comprises:
wsⱼₖ^{l}xⱼₖ^{l}≤tⱼₖ^{k},j∈J,k∈M,l∈TWⱼₖ
(weⱼₖ^{l}−pⱼ)·xⱼₖ^{l}≥tⱼₖ^{l},j∈J,k∈M,l∈TWⱼₖ
wherein tⱼ, j∈J∪{0, n+1} is the second variable, indicating the start time corresponding to the time window twⱼₖ^{l} to which a workpiece j is assigned, and pⱼ indicates processing time.

5. The scheduling method of the unrelated parallel machine according to claim 3, wherein the processing the second object to be processed before the first object to be processed in response to determining that the latest end time of the first object to be processed is less than the sum of the earliest start time of the second object to be processed and the switching time of the implementer comprises:
tᵢₖ^{g}−tⱼₖ^{l}≥(pⱼ+Δₖ)·xⱼₖ^{l}−(weⱼₖ^{l}+Δₖ)·(1−xᵢₖ^{g})
wherein, tⱼ, j∈J∪{0, n+1} represents the second variable, pⱼ represents the processing time, and Δₖ represents the -switching time of the implementer for each implementer k, k∈M;
the processing the second object to be processed after the first object to be processed in response to determining that the latest end time of the first object to be processed is greater than the sum of the earliest start time of the second object to be processed and the switching time of the implementer comprises:
tⱼₖ^{l}−tᵢₖ^{g}≥(pᵢ+Δₖ)·xᵢₖ^{g}−(weᵢₖ^{g}+Δₖ)·(1−xⱼₖ^{l})

6. The scheduling method of the unrelated parallel machine according to claim 3, wherein the third variable and the fourth variable satisfy the switching time constraint, the consistency constraint and the domain constraint, the switching time constraint comprising:
tⱼₖ^{l}−tᵢₖ^{g}≥(weᵢₖ^{g}+Δₖ)·yᵢⱼₖ^{g}^{ₗ}+weⱼₖ^{l}·yⱼᵢₖ^{l}^{_{g}}−(weᵢₖ^{g}−pᵢ)
tᵢₖ^{g}−tⱼₖ^{l}≥(weⱼₖ^{l}+Δₖ)·yⱼᵢₖ^{l}^{_{g}}+wsᵢₖ^{g}·yᵢⱼₖ^{g}^{ₗ}−(weⱼₖ^{l}−pⱼ)
wherein, tⱼ, j∈J∪{0, n+1} represents the second variable, pⱼ represents the processing time and Δₖ represents the switching time of the implementer for each implementer k, k∈M, yᵢⱼₖ^{g}^{ₗ} is the third variable and yⱼᵢₖ^{l}^{_{g}} is the fourth variable, and in response to determining that an object to be processed i is processed before an object to be processed j, yᵢⱼₖ^{g}^{ₗ}=1 and in response to determining that the object to be processed j is processed before the object to be processed i, yⱼᵢₖ^{l}^{_{g}}=1;
the consistency constraint comprising:
$${y}_{ijk}^{gl} + {y}_{jik}^{lg} \leq {x}_{ik}^{g} , i , j ∈ J , k ∈ M , g ∈ {TW}_{ik} , l ∈ {TW}_{jk}$$
$${y}_{ijk}^{gl} + {y}_{jik}^{lg} \leq {x}_{jk}^{l} , i , j ∈ J , k ∈ M , g ∈ {TW}_{ik} , l ∈ {TW}_{jk}$$
$${y}_{ijk}^{gl} + {y}_{jik}^{lg} \geq {x}_{ik}^{g} + {x}_{jk}^{l} - 1 , i , j ∈ J , k ∈ M , g ∈ {TW}_{ik} , l ∈ {TW}_{jk}$$
$${\sum }_{k ∈ M} {\sum }_{g ∈ {TW}_{ik}} {\sum }_{l ∈ {TW}_{jk}} {y}_{ijk}^{gl} + {y}_{jik}^{lg} \leq 1 , i , j ∈ J .$$
the domain constraint comprising:
yᵢⱼₖ^{g}^{ₗ}∈{0,1},i,j∈J∪{0,n+1},k∈M,g∈TWᵢₖ,l∈TWⱼₖ
tᵢⱼ^{k}∈R⁺,i,j∈J,k∈M.

7. The scheduling method of the unrelated parallel machine according to claim 3, wherein scheduling remaining objects to be processed comprises:
in response to determining that the number of accessed time windows is two, letting η^{k}ᵢⱼ=pᵢ+pⱼ+Δₖ, where pᵢ and pⱼ represent processing time of the objects to be processed I and j, and Δₖ represents the switching time, and the overlapping time windows of the objects I and j to be processed are [wsᵢₖ^{l}^{ᵢ}, weᵢₖ^{l}^{ᵢ}], [wsⱼₖ^{l}^{ⱼ}, weⱼₖ^{l}^{ⱼ}];
in response to determining wsᵢₖ^{l}^{ᵢ}≤wsⱼₖ^{l}^{ⱼ}≤weᵢₖ^{l}^{ᵢ}≤weⱼₖ^{l}^{ⱼ}, if weⱼₖ^{l}^{ⱼ}−wsᵢₖ^{l}^{ᵢ}≥ηijk, the objects I and j to be processed can be successfully scheduled, letting the first variable xᵢₖ^{l}^{ᵢ}=xⱼₖ^{l}^{ⱼ}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}};
in response to the determining wsᵢₖ^{l}^{ᵢ}≤wsⱼₖ^{l}^{ⱼ}≤weⱼₖ^{l}^{ⱼ}≤weᵢₖ^{l}^{ᵢ}, if weⱼₖ^{l}^{ⱼ}−wsᵢₖ^{l}^{ᵢ}≥ηijk, the objects i and j to be processed can be successfully scheduled, letting the first variable xᵢₖ^{l}^{ᵢ}=xⱼₖ^{l}^{ⱼ}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}; if weᵢₖ^{l}^{ᵢ}−wsⱼₖ^{l}^{ⱼ}≥ηijk, the objects i and j to be processed can be successfully scheduled, letting the first variable xᵢₖ^{l}^{ᵢ}=xⱼₖ^{l}^{ⱼ}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ.

8. The scheduling method of the unrelated parallel machine according to claim 6, wherein scheduling remaining objects to be processed comprises:
in response to determining that the number of accessed time windows is three, letting wsᵢₖ^{l}^{ᵢ}≤wsⱼₖ^{l}^{ⱼ}≤ws_{qk}^{l}^{_{q}},
η^{k}_{ijq}=pᵢ+pⱼ+p_{q}+2·Δₖ, η^{k}ᵢⱼ=pᵢ+pⱼ+Δₖ, η^{k}_{jq}=pⱼ+p_{q}+Δₖ, η^{k}_{iq}=pᵢ+p_{q}+Δₖ, where pᵢ, pⱼ and p_{q} represent the objects i, j and q to be processed respectively, Δₖ represents the switching time, the three overlapping time windows of the objects i, j and q to be processed are: [wsᵢₖ^{l}^{ᵢ}, weᵢₖ^{l}^{ᵢ}], [wsⱼₖ^{l}^{ⱼ}, weⱼₖ^{l}^{ⱼ}] and [ws_{qk}^{l}^{_{q}}, we_{qk}^{l}^{_{q}}];
in response to determining wsᵢₖ^{l}^{ᵢ}≤wsⱼₖ^{l}^{ⱼ}≤ws_{qk}^{l}^{_{q}}<weᵢₖ^{l}^{ᵢ}≤weⱼₖ^{l}^{ⱼ}≤we_{qk}^{l}^{_{q}}, if we_{qk}^{l}^{_{q}}−wsᵢₖ^{l}^{ᵢ}≥η_{ijq}^{k}, weⱼₖ^{l}^{ⱼ}−wsᵢₖ^{l}^{ᵢ}≥ηijk and we_{qk}^{l}^{_{q}}−wsⱼₖ^{l}^{ⱼ}≥η_{jq}^{k}, the objects i, j and k to be processed can be successfully scheduled, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}};
in response to determining wsᵢₖ^{l}^{ᵢ}≤weⱼₖ^{l}^{ⱼ}<weᵢₖ^{l}^{ᵢ}≤ws_{qk}^{l}^{_{q}}<weⱼₖ^{l}^{ⱼ}≤we_{qk}^{l}^{_{q}}, if we_{qk}^{l}^{_{q}}−weᵢₖ^{l}^{ᵢ}≥η_{ijq}^{k}, weⱼₖ^{l}^{ⱼ}−wsᵢₖ^{l}^{ᵢ}≥ηijk and we_{qk}^{l}^{_{q}}−weⱼₖ^{l}^{ⱼ}≥η_{jq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}};
in response to determining wsᵢₖ^{l}^{ᵢ}≤wsⱼₖ^{l}^{ⱼ}≤ws_{qk}^{l}^{ⱼ}≤weᵢₖ^{l}^{ᵢ}<we_{qk}^{l}^{_{q}} and we_{qk}^{l}^{_{q}}−weᵢₖ^{l}^{ᵢ}≥η_{ijq}^{k}, if weⱼₖ^{l}^{ⱼ}−wsᵢₖ^{l}^{ᵢ}≥ηijk and we_{qk}^{l}^{_{q}}−max{weᵢₖ^{l}^{ᵢ}+pᵢ+Δₖ, weⱼₖ^{l}^{ⱼ}}≥η_{jq}^{k}, letting the first variable xᵢⱼ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, tⱼₖ^{l}^{ⱼ}=max{tⱼₖ^{l}^{ⱼ}+pⱼ+Δₖ, we_{qk}^{l}^{_{q}}}; and if weⱼₖ^{l}^{ⱼ}−wsᵢₖ^{l}^{ᵢ}≥ηijk and we_{qk}^{l}^{_{q}}−weⱼₖ^{l}^{ⱼ}≥η_{ijq}^{k}, let the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, ws_{qk}^{l}^{_{q}}};
in response to determining wsᵢₖ^{l}^{ᵢ}≤wsⱼₖ^{l}^{ⱼ}≤ws_{qk}^{l}^{_{q}}<weⱼₖ^{l}^{ⱼ}<we_{qk}^{l}^{_{q}}≤weᵢₖ^{l}^{ᵢ} and weᵢₖ^{l}^{ᵢ}−wsᵢₖ^{l}^{ᵢ}≥η_{ijq}^{k}, if we_{qk}^{l}^{_{q}}−wsⱼₖ^{l}^{ⱼ}≥η_{jq}^{k} and we_{qk}^{l}^{_{q}}−wsᵢₖ^{l}^{ᵢ}≥η_{ijq}^{k} and weⱼₖ^{l}^{ⱼ}−wsᵢₖ^{l}^{ᵢ}≥ηijk, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}; if we_{qk}^{l}^{_{q}}−wsⱼₖ^{l}^{ⱼ}≥η_{jq}^{k} and weᵢₖ^{l}^{ᵢ}−ws_{qk}^{l}^{_{q}}≥η_{ijq}^{k} and weᵢₖ^{l}^{ᵢ}−ws_{qk}^{l}^{_{q}}≥η_{iq}^{k}, letting the first variable xᵢₖ^{l}^{ᵢ}−wsⱼₖ^{l}^{ⱼ}=x_{qk}^{l}^{_{q}}=1 and the second variable tⱼₖ^{l}^{ⱼ}=wsⱼₖ^{l}^{ⱼ}, t_{qk}^{l}^{_{q}}=max{tⱼₖ^{l}^{ⱼ}+pⱼ+Δₖ, ws_{qk}^{l}^{_{q}}}, tᵢₖ^{l}^{ᵢ}=t_{qk}^{l}^{_{q}}+p_{q}+Δₖ; and if we_{qk}^{l}^{_{q}}−wsⱼₖ^{l}^{ⱼ}≥η_{ijq}^{k}, letting the first variable xᵢₖ^{l}^{ᵢ}=x_{jq}^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, ws_{qk}^{l}^{_{q}}};
in response to determining wsᵢₖ^{l}^{ᵢ}≤wsⱼₖ^{l}^{ⱼ}≤ws_{qk}^{l}^{_{q}}<weᵢₖ^{l}^{ᵢ}≤we_{qk}^{l}^{_{q}} and we_{qk}^{l}^{_{q}}−wsᵢₖ^{l}^{ᵢ}≥η_{ijq}^{k}, if weⱼₖ^{l}^{ⱼ}−wsᵢₖ^{l}^{ᵢ}≥ηijk, letting the first variable xᵢⱼ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=ws_{qk}^{l}^{_{q}}; and if weᵢₖ^{l}^{ᵢ}−wsⱼₖ^{l}^{ⱼ}≥ηijk and we_{qk}^{l}^{_{q}}−wsⱼₖ^{l}^{ⱼ}≥η_{ijq}^{k}, letting the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, tᵢₖ^{l}^{ᵢ}=tⱼₖ^{l}^{ⱼ}+pⱼ+Δₖ, t_{qk}^{l}^{_{q}}=max{tᵢₖ^{l}^{ᵢ}+pᵢ+Δₖ, we_{qk}^{l}^{_{q}}};
in response to determining wsᵢₖ^{l}^{ᵢ}≤wsⱼₖ^{l}^{ⱼ}<weᵢₖ^{l}^{ᵢ}≤ws_{qk}^{l}^{_{q}}<we_{qk}^{l}^{_{q}}≤weⱼₖ^{l}^{ⱼ} and weⱼₖ^{l}^{ⱼ}−wsᵢₖ^{l}^{ᵢ}≥η_{ijq}^{k}, if weⱼₖ^{l}^{ⱼ}−ws_{qk}^{l}^{_{q}}≥η_{jq}^{k}, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=we_{qk}^{l}^{_{q}}, tⱼₖ^{l}^{ⱼ}=t_{qk}^{l}^{_{q}}+p_{q}+Δₖ; and if we_{qk}^{l}^{_{q}}−wsⱼₖ^{l}^{ⱼ}≥η_{jq}^{k} and we_{qk}^{l}^{_{q}}−wsᵢₖ^{l}^{ᵢ}≥η_{ijq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, weⱼₖ^{l}^{ⱼ}}, t_{qk}^{l}^{_{q}}=max{tⱼₖ^{l}^{ⱼ}+pⱼ+Δₖ, we_{qk}^{l}^{_{q}}};
in response to determining wsᵢₖ^{l}^{ᵢ}≤wsⱼₖ^{l}^{ⱼ}<weⱼₖ^{l}^{ⱼ}≤we_{qk}^{l}^{_{q}}<we_{qk}^{l}^{_{q}}≤weᵢₖ^{l}^{ᵢ} and weᵢₖ^{l}^{ᵢ}−weᵢₖ^{l}^{ᵢ}≥η_{ijq}^{k}, if weⱼₖ^{l}^{ⱼ}−wsᵢₖ^{l}^{ᵢ}≥ηijk, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=ws_{qk}^{l}^{_{q}}, tⱼₖ^{l}^{ⱼ}=max{tᵢₖ^{l}^{ᵢ}+pᵢ+Δₖ, weⱼₖ^{l}^{ⱼ}}; if weᵢₖ^{l}^{ᵢ}−ws_{qk}^{l}^{_{q}}≥η_{iq}^{k}, letting the first variable xᵢₖ^{l}^{ᵢ}=xⱼₖ^{l}^{ⱼ}=x_{qk}^{l}^{_{q}}=1 and the second variable t_{qk}^{l}^{_{q}}=ws_{qk}^{l}^{_{q}}, tⱼₖ^{l}^{ⱼ}=wsⱼₖ^{l}^{ⱼ}, tᵢₖ^{l}^{ᵢ}=t_{qk}^{l}^{_{q}}+p_{q}+Δₖ; and if we_{qk}^{l}^{_{q}}−wsⱼₖ^{l}^{ⱼ}≥η_{ijq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=tⱼₖ^{l}^{ⱼ}+pⱼ+Δₖ, tⱼₖ^{l}^{ⱼ}=wsⱼₖ^{l}^{ⱼ}, t_{qk}^{l}^{_{q}}={tᵢₖ^{l}^{ᵢ}+pᵢ+Δₖ, ws_{qk}^{l}^{_{q}}};
in response to determining wsᵢₖ^{l}^{ᵢ}<wsⱼₖ^{l}^{ⱼ}≤ws_{qk}^{l}^{_{q}}<weᵢₖ^{l}^{ᵢ}≤we_{qk}^{l}^{_{q}}≤weⱼₖ^{l}^{ⱼ} and weⱼₖ^{l}^{ⱼ}−wsᵢₖ^{l}^{ᵢ}≥η_{ijq}^{k}, if weⱼₖ^{l}^{ⱼ}−max{wsᵢₖ^{l}^{ᵢ}+pᵢ+Δₖ, we_{qk}^{l}^{_{q}}}≥η_{jq}^{k}, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, we_{qk}^{l}^{_{q}}}, tⱼₖ^{l}^{ⱼ}=t_{qk}^{l}^{_{q}}+p_{q}+Δₖ; and if we_{qk}^{l}^{_{q}}−max{wsᵢₖ^{l}^{ᵢ}+pᵢ+Δₖ, wsⱼₖ^{l}^{ⱼ}}≥η_{jq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}};
in response to determining wsᵢₖ^{l}^{ᵢ}≤wsⱼₖ^{l}^{ⱼ}≤ws_{qk}^{l}^{_{q}}<we_{qk}^{l}^{_{q}}≤weⱼₖ^{l}^{ⱼ}≤weᵢₖ^{l}^{ᵢ} and weᵢₖ^{l}^{ᵢ}−wsᵢₖ^{l}^{ᵢ}≥η_{ijq}^{k}, if we_{qk}^{l}^{_{q}}−wsᵢₖ^{l}^{ᵢ}≥η_{ijq}^{k} and we_{qk}^{l}^{_{q}}−wsⱼₖ^{l}^{ⱼ}≥η_{jq}^{k}, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+pⱼ+Δₖ, ws_{qk}^{l}^{_{q}}}; if weⱼₖ^{l}^{ⱼ}−wsᵢₖ^{l}^{ᵢ}≥η_{ijq}^{k} and weⱼₖ^{l}^{ⱼ}−max{wsᵢₖ^{l}^{ᵢ}+pᵢ+Δₖ, ws_{qk}^{l}^{_{q}}}≥η_{jq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, ws_{qk}^{l}^{_{q}}}, tⱼₖ^{l}^{ⱼ}=t_{qk}^{l}^{_{q}}+p_{q}+Δₖ; if we_{qk}^{l}^{_{q}}−wsⱼₖ^{l}^{ⱼ}≥η_{jq}^{k} and weᵢₖ^{l}^{ᵢ}−max{wsⱼₖ^{l}^{ⱼ}+pⱼ+Δₖ, ws_{qk}^{l}^{_{q}}}≥η_{iq}^{k}, letting the first variable xᵢₖ^{l}^{ᵢ}=xⱼₖ^{l}^{ⱼ}=x_{qk}^{l}^{_{q}}=1 and the second variable tⱼₖ^{l}^{ⱼ}=wsⱼₖ^{l}^{ⱼ}, t_{qk}^{l}^{_{q}}=max{tⱼₖ^{l}^{ⱼ}+pⱼ+Δₖ, ws_{qk}^{l}^{_{q}}}, tᵢₖ^{l}^{ᵢ}=t_{qk}^{l}^{_{q}}+p_{q}+Δₖ; and if weᵢₖ^{l}^{ᵢ}−ws_{qk}^{l}^{_{q}}≥η_{ijq}^{k} and weⱼₖ^{l}^{ⱼ}−ws_{qk}^{l}^{_{q}}≥η_{jq}^{k}, letting the first variable xᵢₖ^{l}^{ᵢ}=xⱼₖ^{l}^{ⱼ}=x_{qk}^{l}^{_{q}}=1 and the second variable tⱼₖ^{l}^{ⱼ}=t_{qk}^{l}^{_{q}}+p_{q}+Δₖ, t_{qk}^{l}^{_{q}}=ws_{qk}^{l}^{_{q}}, tᵢₖ^{l}^{ᵢ}=tⱼₖ^{l}^{ⱼ}+pⱼ+Δₖ; and
in response to determining wsᵢₖ^{l}^{ᵢ}≤wsⱼₖ^{l}^{ⱼ}≤ws_{qk}^{l}^{_{q}}<we_{qk}^{l}^{_{q}}≤weᵢₖ^{l}^{ᵢ}<weⱼₖ^{l}^{ⱼ} and weⱼₖ^{l}^{ⱼ}−wsᵢₖ^{l}^{ᵢ}≥η_{ijq}^{k}, if we_{qk}^{l}^{_{q}}−wsᵢₖ^{l}^{ᵢ}≥η_{ijq}^{k} and we_{qk}^{l}^{_{q}}−wsⱼₖ^{l}^{ⱼ}≥η_{jq}^{k}, letting the first variable xᵢₖ^{l}^{ᵢ}=xⱼₖ^{l}^{ⱼ}=x_{qk}^{l}^{_{q}}=1, the second variable tᵢₖ^{l}^{ᵢ}=wsᵢₖ^{l}^{ᵢ}, tⱼₖ^{l}^{ⱼ}=max{tᵢₖ^{l}^{ᵢ}+pᵢ+Δₖ, wsⱼₖ^{l}^{ⱼ}}, t_{qk}^{l}^{_{q}}=max{tⱼₖ^{l}^{ⱼ}+p_{q}+Δₖ, ws_{qk}^{l}^{_{q}}}; if we_{qk}^{l}^{_{q}}−wsᵢₖ^{l}^{ᵢ}≥η_{ijq}^{k} and weⱼₖ^{l}^{ⱼ}−ws_{qk}^{l}^{_{q}}≥η_{jq}^{k}, letting the first variable xᵢₖ^{l}^{ᵢ}=xⱼₖ^{l}^{ⱼ}=x_{qk}^{l}^{_{q}}=1 and the second variable tᵢₖ^{l}^{ᵢ}=wsᵢₖ^{l}^{ᵢ}, t_{qk}^{l}^{_{q}}=max{tᵢₖ^{l}^{ᵢ}+pᵢ+Δₖ, ws_{qk}^{l}^{_{q}}}, tⱼₖ^{l}^{ⱼ}=t_{qk}^{l}^{_{q}}+p_{q}+Δₖ; and if weᵢₖ^{l}^{ᵢ}−ws_{qk}^{l}^{_{q}}≥η_{iq}^{k} and weⱼₖ^{l}^{ⱼ}−ws_{qk}^{l}^{_{q}}≥η_{ijq}^{k}, letting the first variable xᵢₖ^{l}^{ᵢ}=xⱼₖ^{l}^{ⱼ}=x_{qk}^{l}^{_{q}}=1 and the second variable t_{qk}^{l}^{_{q}}=ws_{qk}^{l}^{_{q}}, tᵢₖ^{l}^{ᵢ}=t_{qk}^{l}^{_{q}}+p_{q}+Δₖ, tⱼₖ^{l}^{ⱼ}=tᵢₖ^{l}^{ᵢ}+pᵢ+Δₖ.

9. A scheduling device for an unrelated parallel machine, comprising:
a first processing module configured to process a first object to be processed within a corresponding time window in response to determining that a first variable is 1, and take a second variable to be 0 in response to determining that the first variable is 0; and schedule the first object to be processed according to the first variable and the second variable, wherein the first variable indicates whether the first object to be processed is scheduled to a time window corresponding to an implementer, if the first object to be processed is scheduled to the time window corresponding to the implementer, the first variable is 1, otherwise, the first variable is 0; and the second variable indicates a start time when the first object to be processed is allocated to the time window, and each object to be processed is processed at most once;
a second processing module configured to process a second object to be processed before the first object to be processed in response to determining that a latest end time of the first object to be processed is less than a sum of an earliest start time of the second object to be processed and a switching time of the implementer; and process the second object to be processed after the first object to be processed in response to determining that the latest end time of the first object to be processed is greater than the sum of the earliest start time of the second object to be processed and the switching time of the implementer;
a third processing module configured to process the first object to be processed before the second object to be processed in response to determining that a third variable is 1; and process the first object to be processed after the second object to be processed in response to determining that a fourth variable is 1; wherein the third variable and the fourth variable respectively indicate scheduling orders of the first object to be processed and the second object to be processed, and the third variable and the fourth variable satisfy a switching time constraint, a consistency constraint and a domain constraint;
a scheduling module configured to establish a mixed integer linear programming model according to above conditions, solving the mixed integer linear programming model to obtain a scheduling scheme for scheduling an object to be processed with a maximum total revenue, and schedule each object to be processed according to the scheduling scheme, thus obtaining an improved upper bound for a linear relaxation of the mixed integer linear programming model;
thereby improving efficiency in scheduling at least the first object to be processed and the second object to be processed via the implementer; and
operating the implementer to perform switching operations according to the scheduling scheme; wherein:
the implementer comprises at least one satellite in at least one orbit the first object to be processed comprises a first observation target of the at least one satellite and the second object to be processed comprises a second observation target of the at least one satellite;
the switching operations are performed between continuously observing the first observation target and the second observation target;
the switching operations comprise sensor shutdown, yawing, attitude stabilization and restarting; and
visibility is determined by the at least one orbit of the at least one satellite and a target position, and thus time windows of observation are calculated based on the first observation target, the second observation target, and the at least one satellite;
thus the first observation target and the second observation target are pre-scheduled, thereby reducing a scale of problem solving with addition of effective inequalities, and a tighter upper bound of linear relaxation of the mixed integer linear programming model facilitates problem solving.

10. An electronic device, comprising a memory, a processor and a computer program stored on the memory and operable on the processor, the processor implementing the method of claim 1 when executing the program.
